(19) United States
(12) Patent Application Publication
(10) Pub. No.: US 2025/0291053 A1
(43) Pub. Date: Sep. 18, 2025

(54) INFRASTRUCTURE RADIO WAVE SENSOR

(71) Applicant: Sumitomo Electric Industries, Ltd., Osaka-shi, Osaka (JP)

(72) Inventor: Atsushi HIGASHI, Osaka-shi, Osaka (JP)

(73) Assignee: Sumitomo Electric Industries, Ltd., Osaka-shi, Osaka (JP)

(21) Appl. No.: 18/860,014

(22) PCT Filed: Feb. 10, 2023
(86) PCT No.: PCT/JP2023/004487

§ 371 Date: Oct. 25, 2024

(30) Foreign Application Priority Data
Apr. 27, 2022 (JP) 2022-072873

(51) Int. Cl. G01S 13/92; G01S 7/00; G08G 1/005

(52) U.S. Cl. CPC G01S 13/92; G01S 7/003; G08G 1/005

(57) ABSTRACT

An infrastructure radio wave sensor includes: a transmission unit configured to transmit radio waves to a detection area that includes a pedestrian crossing; a reception unit configured to receive reflected waves that are the radio waves reflected from an object; and an output unit configured to output a message created based on a reception result of the reflected waves received by the reception unit, wherein the message includes at least one of a vehicle presence status indicating that a vehicle stopped at a stop line, provided on roadway intersecting the pedestrian crossing, is present, a number of vehicles indicating a number of vehicles traveling on the roadway, and an event occurrence status indicating that a sudden event has occurred to a road user on the pedestrian crossing.

### TECHNICAL FIELD

The present disclosure relates to an infrastructure radio wave sensor.

The present application claims priority under Japanese Patent Application No. 2022-072873, filed on Apr. 27, 2022, the entire contents of which are hereby incorporated by reference.

### BACKGROUND ART

PTL 1 discloses a control method for detecting, with the use of a laser sensor, the number of road users waiting for the signal in a signal waiting area of a pedestrian crossing, and modifying the set value of a red period (prohibited passage period) of a pedestrian traffic light according to the detected number of road users. PTL 1 further discloses modifying the set value of a blue period (permitted passage period) of the pedestrian traffic light in response to detection of a road user on the pedestrian crossing.

### CITATION LIST

### Patent Literature

PTL 1: Japanese Unexamined Patent Application Publication No. 2003-217086

### SUMMARY OF INVENTION

An infrastructure radio wave sensor according to an aspect of the present disclosure includes: a transmission unit configured to transmit radio waves to a detection area that includes a pedestrian crossing; a reception unit configured to receive reflected waves that are the radio waves reflected from an object; and an output unit configured to output a message created based on a reception result of the reflected waves received by the reception unit, wherein the message includes at least one of a vehicle presence status indicating that a vehicle stopped at a stop line, provided on roadway intersecting the pedestrian crossing, is present, a number of vehicles indicating a number of vehicles traveling on the roadway, and an event occurrence status indicating that a sudden event has occurred to a road user on the pedestrian crossing.

### BRIEF DESCRIPTION OF DRAWINGS

FIG. 1 is a diagram illustrating a usage example of an infrastructure radio wave sensor according to a first embodiment.

FIG. 2 is a block diagram illustrating an example of an internal configuration of the infrastructure radio wave sensor according to the first embodiment.

FIG. 3 is a functional block diagram illustrating an example of functions of the infrastructure radio wave sensor according to the first embodiment.

FIG. 4 is a diagram for explaining an example of an area for object detection for the infrastructure radio wave sensor according to the first embodiment.

FIG. 5 is a flowchart illustrating an example of an object detection process.

FIG. 6 is a flowchart illustrating an example of a tracking process.

FIG. 7 is a flowchart illustrating an example of a stopped vehicle detection process.

FIG. 8 is a flowchart illustrating an example of a vehicle counting process.

FIG. 9 is a flowchart illustrating an example of a passage time prediction process.

FIG. 10 is a flowchart illustrating an example of a sudden event detection process.

FIG. 11 is a flowchart illustrating an example of a first reliability determination process.

FIG. 12 is a flowchart illustrating an example of a second reliability determination process.

FIG. 13 is a flowchart illustrating an example of a message creation process.

FIG. 14 is a functional block diagram illustrating an example of functions of an infrastructure radio wave sensor according to a second embodiment.

FIG. 15 is a diagram for explaining cells.

FIG. 16 is a diagram for explaining an example of the determination of a crossing intention.

FIG. 17 is a flowchart illustrating an example of a presence determination process.

FIG. 18 is a flowchart illustrating an example of a third reliability determination process.

FIG. 19 is a flowchart illustrating an example of a standby time determination process.

FIG. 20 is a flowchart illustrating an example of a density determination process.

FIG. 21 is a flowchart illustrating an example of a type identification process.

FIG. 22 is a flowchart illustrating an example of a statistic calculation process.

FIG. 23 is a flowchart illustrating an example of a crossing intention determination process.

FIG. 24 is a flowchart illustrating an example of a message creation process.

FIG. 25 is a diagram illustrating an example of a detection area for vehicle drive assistance.

### DETAILED DESCRIPTION

### Problems to be Solved by Present Disclosure

In order to improve the convenience for road users and vehicles, it is desirable to control pedestrian traffic lights in response to more diverse traffic conditions. It is also desirable to provide a variety of traffic information to road users crossing pedestrian crossings and to vehicles traveling on roadways intersecting the pedestrian crossings.

### Advantageous Effects of Present Disclosure

According to the present disclosure, an infrastructure radio wave sensor that outputs messages in response to various traffic conditions can be implemented.

### Overview of Embodiments of Present Disclosure

An overview of an embodiment of the present disclosure will be set forth below.

(1) An infrastructure radio wave sensor according to the present embodiment includes: a transmission unit configured to transmit radio waves to a detection area that includes a pedestrian crossing; a reception unit configured to receive reflected waves that are the radio waves reflected from an object; and an output unit configured to output a message created based on a reception result of the reflected waves received by the reception unit, wherein the message includes at least one of a vehicle presence status indicating that a vehicle stopped at a stop line, provided on roadway intersecting the pedestrian crossing, is present, a number of vehicles indicating a number of vehicles traveling on the roadway, and an event occurrence status indicating that a sudden event has occurred to a road user on the pedestrian crossing. This allows the infrastructure radio wave sensor to output messages in response to various traffic conditions.

(2) In (1) described above, the message may include a predicted value of a passage time until the road user on the pedestrian crossing or in a standby area adjacent to the pedestrian crossing finishes crossing the pedestrian crossing, or a predicted value of a passage completion time at which the road user finishes crossing the pedestrian crossing. This allows the infrastructure radio wave sensor to output the predicted value of the passage time or the predicted value of the passage completion time used for controlling a pedestrian traffic light.

(3) In (2) described above, the message may include a reliability of the predicted value of the passage time or the predicted value of the passage completion time. This allows the predicted value of the passage time or the predicted value of the passage completion time, based on the reliability, to be used for controlling a pedestrian traffic light.

(4) In (3) described above, the reliability of at least one of the predicted value of the passage time and the predicted value of the passage completion time may be determined based on at least one of a velocity or an acceleration of the road user, an overlap between objects, a movement direction of the road user, and a tracking time of the road user in the infrastructure radio wave sensor. This enables the determination of the reasonable reliability.

(5) In any of (1) to (3) described above, the message may include a reliability of the sudden event. This allows the event occurrence status, based on the reliability, to be used for controlling a pedestrian traffic light.

(6) In (5) described above, the reliability of the sudden event may be determined based on at least one of a time during which the road user is stopped, and an image of the road user captured by a camera. By using these statuses, the reasonable reliability can be determined.

(7) An infrastructure radio wave sensor according to the present embodiment includes: a transmission unit configured to transmit radio waves to a detection area that includes a pedestrian crossing; a reception unit configured to receive reflected waves that are the radio waves reflected from an object; and an output unit configured to output a message created based on a reception result of the reflected waves received by the reception unit, wherein the message includes a detection result of a road user in each of multiple divided areas into which the detection area is divided. This allows the infrastructure radio wave sensor to output messages in response to various traffic conditions.

(8) In (7) described above, the message may include, as a detection result of the road user, at least one of a presence status indicating whether the road user is present for each of the divided areas, a logical OR of the presence status of the road user, a predicted value of a passage time until the road user in each of the divided areas finishes crossing the pedestrian crossing or a predicted value of a passage completion time at which the road user finishes crossing the pedestrian crossing, a standby time of the road user, for each of the divided areas, in a standby area adjacent to the pedestrian crossing, a density of the road users for each of the divided areas, a type of an object detected for each of the divided areas, a statistic of the road user detected for each of the divided areas, and an intention of the road user in each of the divided areas to cross the pedestrian crossing. This allows the output of messages including statuses in response to various traffic conditions for each of the divided areas.

(9) In (8) described above, the message may include a reliability of the presence status for each of the divided areas. This allows the use of the presence status for each of the divided areas, based on the reliability, for controlling a pedestrian traffic light.

(10) In (9) described above, the reliability of the presence status may be determined based on at least one of a variance value of a position or a velocity of the road user detected in the divided area, an overlap between objects in the divided area, a tracking time of the road user in the infrastructure radio wave sensor, and a likelihood of presence of the road user detected by the infrastructure radio wave sensor. By using these statuses, the reasonable reliability can be determined.

(11) In (9) or (10) described above, the message may include a basis for calculating the reliability. This allows a user to check on what basis the reliability has been calculated.

(12) In any of (1) to (11) described above, the infrastructure radio wave sensor may include a communication unit configured to communicate with an external device, wherein the output unit may set a format of the message based on a request received by the communication unit from the external device. This allows the format of an output message of the infrastructure radio wave sensor to be specified from a server.

The present disclosure can be implemented not only as an infrastructure radio wave sensor with the characteristic configuration described above, but also as a message output method of the infrastructure radio wave sensor for performing characteristic steps, as a computer program for causing a computer to execute the characteristic steps described above, and as a system including the infrastructure radio wave sensor. A portion of the infrastructure radio wave sensor can be implemented as a semiconductor integrated circuit.

### Details of Embodiments of Present Disclosure

Hereinafter, embodiments of the present disclosure will be described in detail with reference to the drawings. Note that at least some portions of the embodiments described below may be optionally combined.

### First Embodiment

### [1-1. Configuration of Infrastructure Radio Wave Sensor]

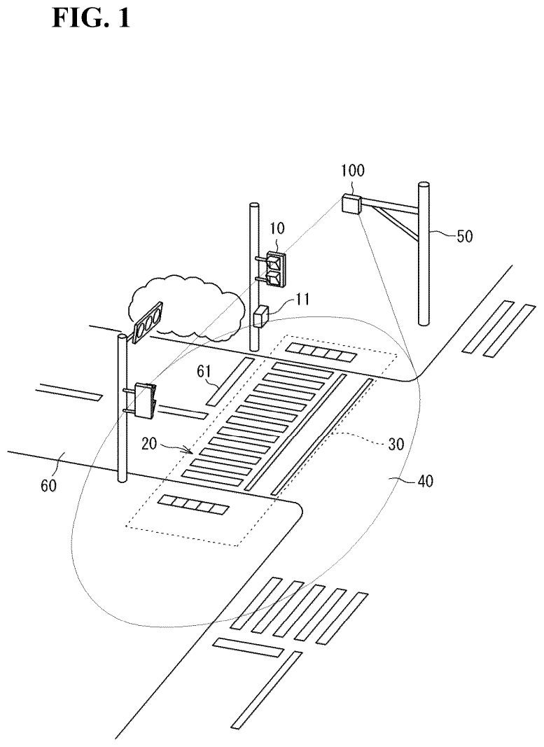

FIG. 1 is a diagram illustrating a usage example of an infrastructure radio wave sensor according to a first embodiment. An infrastructure radio wave sensor 100 according to the first embodiment is a radio wave radar for traffic monitoring, and it detects road users on a pedestrian crossing 20. The infrastructure radio wave sensor 100 is, for example, a millimeter wave radar.

The infrastructure radio wave sensor 100 is attached to a structure 50 provided on the road. The structure 50 has a height of several meters, and the infrastructure radio wave sensor 100 is installed at a height of several meters above the ground.

The infrastructure radio wave sensor 100 detects objects (such as road users, bicycles, and vehicles) on the pedestrian crossing 20 by irradiating the pedestrian crossing 20 with radio waves (millimeter waves) and receiving reflected waves thereof. More specifically, the infrastructure radio wave sensor 100 can detect a distance from the infrastructure radio wave sensor 100 to an object on the pedestrian crossing 20, a velocity of the object, and a horizontal angle (azimuth angle) at a position where the object is present relative to the axis of radio wave irradiation.

Here, individuals crossing the pedestrian crossing 20 and those waiting to cross due to the traffic signal are referred to as “road users.”

Road users include pedestrians and cyclists. The infrastructure radio wave sensor 100 detects road users and detects their position (distance and azimuth angle) as well as their velocity. Furthermore, the infrastructure radio wave sensor 100 can calculate the acceleration of road users based on their velocity. The infrastructure radio wave sensor 100 can detect the movement direction of road users based on changes in their position.

For the infrastructure radio wave sensor 100, a detection area 30, which is a range on the road for detecting objects, is set. The detection area 30 is set as a portion of a radio wave irradiation area 40 of the infrastructure radio wave sensor 100. That is, the radio wave irradiation area 40 covers the detection area 30. The detection area 30 includes the entire pedestrian crossing 20.

The radio wave irradiation area 40 of the infrastructure radio wave sensor 100 according to the first embodiment includes a portion of a roadway 60 intersecting the pedestrian crossing 20. Specifically, the radio wave irradiation area 40 includes a vehicle stop line 61 adjacent to the pedestrian crossing 20, and an area where a vehicle stops at the vehicle stop line 61 (hereinafter referred to as a “vehicle stop area”). The infrastructure radio wave sensor 100 can detect a vehicle traveling on the roadway 60 and a vehicle stopped at the vehicle stop line 61. The term “vehicle” includes automobiles and bicycles.

The infrastructure radio wave sensor 100 is used to control a pedestrian traffic light 10, which is installed on the pedestrian crossing 20. Specifically, the infrastructure radio wave sensor 100 is connected by a signal line (not illustrated) to a control apparatus 11 of the pedestrian traffic light 10, and outputs messages to the control apparatus 11. The messages include those related to the means used to control the pedestrian traffic light 10.

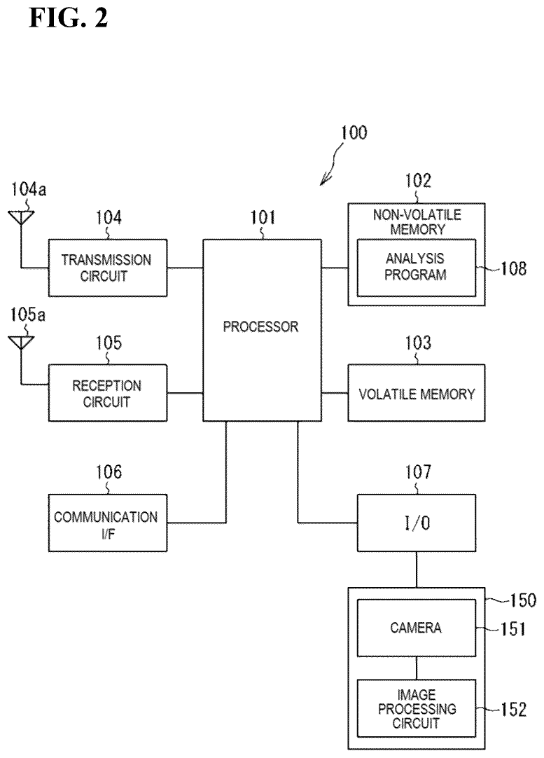

FIG. 2 is a block diagram illustrating an example of an internal configuration of the infrastructure radio wave sensor according to the first embodiment. The infrastructure radio wave sensor 100 includes a processor 101, a non-volatile memory 102, a volatile memory 103, a transmission circuit 104, a reception circuit 105, a communication interface (communication I/F) 106, and an input/output interface (I/O) 107.

The volatile memory 103 is a semiconductor memory such as, for example, SRAM (Static Random Access Memory), DRAM (Dynamic Random Access Memory), etc. The non-volatile memory 102 is, for example, flash memory, hard disk, or ROM (Read Only Memory). The non-volatile memory 102 stores an analysis program 108, which is a computer program, and data used for executing the analysis program 108. Each function of the infrastructure radio wave sensor 100 is implemented by the processor 101 executing the analysis program 108. The analysis program 108 can be stored on a recording medium such as flash memory, ROM, CD-ROM, etc. Using the analysis program 108, the processor 101 can create a message and output the created message.

The processor 101 is, for example, a CPU (Central Processing Unit). Note that the processor 101 is not limited to a CPU. The processor 101 may be a GPU (Graphics Processing Unit). The processor 101 may be, for example, an ASIC (Application Specific Integrated Circuit) or a programmable logic device such as a gate array, an FPGA (Field Programmable Gate Array), etc. In this case, the ASIC or the programmable logic device is configured to be capable of executing processing that is the same as or similar to the analysis program 108.

The transmission circuit 104 includes a transmission antenna 104a. Note that the number of transmission antennas 104a is not limited to one, and may be plural. The transmission circuit 104 generates modulated waves and transmits the generated modulated waves from the transmission antenna 104a. The transmitted modulated waves reflect off an object (e.g., a road user or a vehicle). The transmission circuit 104 is an example of a “transmission unit”.

The reception circuit 105 includes a reception antenna 105a. Note that the number of reception antennas 105a is not limited to one, and may be plural. The reception circuit 105 performs signal processing on the received reflected waves. Reflected wave data generated by the signal processing is provided to the processor 101. The processor 101 analyzes the reflected wave data and detects an object's position (distance and azimuth angle) as well as its velocity. The reception circuit 105 is an example of a “reception unit”.

The communication I/F 106 can communicate with external devices. The communication I/F 106 is connected to the control apparatus 11 via a communication line and is able to transmit (output) messages to the control apparatus 11. The communication I/F 106 is further connected to a server at a traffic control center via a network, and is able to communicate with the server. The communication I/F 106 is an example of an “output unit”.

For example, the communication I/F 106 may include a wireless communication interface for DSRC (Dedicated Short Range Communications). In this case, the communication I/F 106 may send messages to a vehicle traveling on the roadway 60 through road-to-vehicle communication.

The I/O 107 receives and outputs data from and to the outside. As illustrated in FIG. 2, the I/O 107 is connected to a camera device 150. The camera device 150 includes a camera 151 and an image processing circuit 152. The camera 151 is an imaging sensor such as a CCD (Charge Coupled Device) or a CMOS (Complementary Metal Oxide Semiconductor). The image processing circuit 152 processes an image output from the camera 151. The image processing circuit 152 is configured by a CPU and a memory, and the CPU may execute an image processing program or may be configured by an ASIC or programmable logic device for image processing. The camera 151 is directed toward the pedestrian crossing 20 and is able to capture images of an area including the detection area 30. The image processing circuit 152 can detect road users through image processing. The detection result of the camera device 150 is output to the I/O 107. This allows the infrastructure radio wave sensor 100 to output a message including the detection result of road users by the radar and the detection result of road users by the camera device 150. Note that the camera device 150 need not be provided. In this case, the infrastructure radio wave sensor 100 outputs a message created based only on the detection result of road users by the radar.

### [1-2. Functions of Infrastructure Radio Wave Sensor]

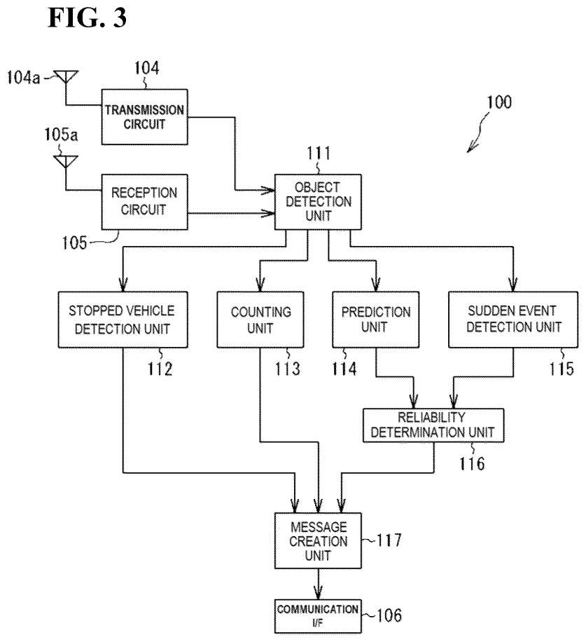

FIG. 3 is a functional block diagram illustrating an example of functions of the infrastructure radio wave sensor 100 according to the first embodiment. By executing the analysis program 108, the processor 101 implements the functions of an object detection unit 111, a stopped vehicle detection unit 112, a counting unit 113, a prediction unit 114, a sudden event detection unit 115, a reliability determination unit 116, and a message creation unit 117.

The object detection unit 111 detects an object in the radio wave irradiation area 40 based on reflected waves, which are radio waves emitted to the object and then reflected back. The transmission circuit 104 transmits a transmission signal, which consists of modulated waves, from the transmission antenna 104a. The transmission signal from the transmission antenna 104a reflects off the object. The reception antenna 105a receives the reflected waves from the object. The object detection unit 111 combines a modulated wave signal output from the transmission circuit 104 with a reflected wave signal output from the reception circuit 105 to generate an intermediate frequency signal (hereinafter referred to as an “IF signal”). The object detection unit 111 applies a fast Fourier transform (FFT) to the IF signal to obtain distance, velocity, and azimuth angle. The distance, velocity, and azimuth angle are represented by the polar coordinate system with the distance from the infrastructure radio wave sensor 100 as the moving diameter and the angle from the direction of radio wave irradiation as the deflection angle.

The reflection intensity of radio waves varies depending on the shape and material of an object's surface, for example. Because the angle and material of an object's surface differ by part of the surface, the reflection intensity of radio waves varies from part to part. That is, reflected waves from a single object includes multiple peaks (hereinafter referred to as “reflection points”). The object detection unit 111 groups together multiple reflection points from a single object in the waveform of the reflected waves and determines a representative value for the reflection points belonging to the same group. One example of a representative value is the center of gravity, while other examples include the median or the mean. The object detection unit 111 assigns the representative value of the group to the single object.

The object detection unit 111 can execute an object tracking process. The tracking process is a process of tracking objects chronologically, and includes a process of determining the identity of an object detected at one point in time and an object detected at another point in time. The tracking process uses the position and velocity of previously detected objects. For example, the object detection unit 111 estimates the position, velocity, and movement direction of object A at time T2 from the position, velocity, and movement direction of object A detected at time T1. The object detection unit 111 then determines, from among objects detected at time T2, one that has the position, velocity, and movement direction closest to the estimated position, velocity, and movement direction as object A.

The object detection unit 111 identifies the type of a detected object. Types include road users and vehicles. Type identification uses the size, velocity, position, and movement direction of a detected object. For example, if the object's velocity is less than 5 km/h, its size is less than 2 m, it is present in the detection area 30, and its movement direction is along the pedestrian crossing 20, then the object detection unit 111 identifies this object as a road user. For example, if the object's velocity is 30 km/h or more and its size is 2 m or more, the object detection unit 111 identifies this object as a vehicle.

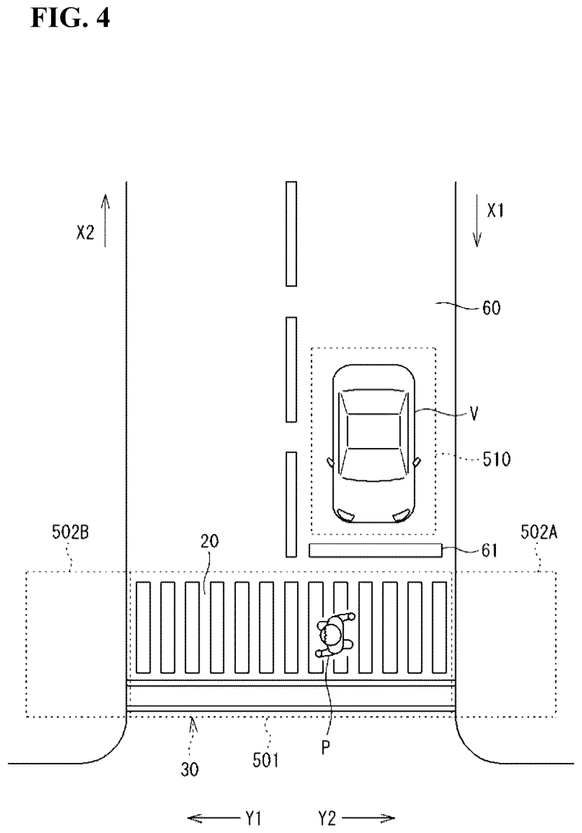

The stopped vehicle detection unit 112 detects a vehicle stopped at the vehicle stop line 61 of the roadway 60 (hereinafter referred to as a “stopped vehicle”). FIG. 4 is a diagram for explaining an example of an area for object detection for the infrastructure radio wave sensor 100 according to the first embodiment. In a lane where vehicles travel in X1 direction of the roadway 60, a vehicle stop area 510 is set in the vicinity of the vehicle stop line 61. The vehicle stop area 510 is an area where a vehicle V stops at the vehicle stop line 61 in order to wait for the signal. Using the vehicle stop area 510, the infrastructure radio wave sensor 100 detects the vehicle V stopped at the vehicle stop line 61. The non-volatile memory 102 of the infrastructure radio wave sensor 100 stores the position of the vehicle stop area 510.

Referring back to FIG. 3, the stopped vehicle detection unit 112 determines whether a vehicle V detected by the object detection unit 111 is located in the vehicle stop area 510. If a vehicle V located in the vehicle stop area 510 is present, the stopped vehicle detection unit 112 refers to the past detection results, and determines whether the vehicle V has been continuously located in the vehicle stop area 510 for a certain first determination time or longer. If the vehicle V has been continuously located in the vehicle stop area 510 for the first determination time or longer, the stopped vehicle detection unit 112 determines the vehicle V to be a stopped vehicle.

The counting unit 113 counts vehicles V passing through the detection area 30 of the roadway 60 within a certain counting time. Specifically, the counting unit 113 counts the number of vehicles V that travel in X1 direction along the roadway 60 and pass through the detection area 30 from the detection results of the object detection unit 111 within the counting time, and counts the number of vehicles V that travel in X2 direction opposite to X1 direction and pass through the detection area 30.

The prediction unit 114 predicts the remaining time until a road user P who is crossing the pedestrian crossing 20 finishes crossing the pedestrian crossing 20 (hereinafter referred to as the “passage time”). Now refer to FIG. 4. The detection area 30 includes a pedestrian crossing area 501 and standby areas 502A and 502B. The pedestrian crossing area 501 is an area that includes the pedestrian crossing 20 and has the same width as the width (length in X1 direction) of the pedestrian crossing 20 or slightly more than the width of the pedestrian crossing 20, and has the same length as the length (length in Y1 direction) of the pedestrian crossing 20 or slightly more than the length of the pedestrian crossing 20. The pedestrian crossing area 501 is a rectangular area surrounding the pedestrian crossing 20. The standby area 502A is an area adjacent to one end in Y1 direction of the pedestrian crossing 20. The standby area 502B is an area adjacent to another end in Y1 direction of the pedestrian crossing 20. The standby areas 502A and 502B are located apart from each other in Y1 direction, across the pedestrian crossing 20. The standby area 502A is an area where road users who will cross the pedestrian crossing 20 in Y1 direction wait for the signal, and the standby area 502B is an area where road users who will cross the pedestrian crossing 20 in Y2 direction wait for the signal.

The prediction unit 114 calculates a distance L (hereinafter referred to as a “remaining passage distance”) from the position of a road user P detected in the pedestrian crossing area 501 to a target end of the pedestrian crossing 20 (i.e., an end to be reached when the road user P proceeds in the movement direction). If the movement direction of the road user P is Y1, the remaining passage distance L is a distance from the position of the road user P to the boundary between the pedestrian crossing 20 and the standby area 502B. If the movement direction of the road user P is Y2, the remaining passage distance L is a distance from the position of the road user P to the boundary between the pedestrian crossing 20 and the standby area 502A. The prediction unit 114 divides the calculated remaining passage distance L by the velocity v of the road user P to calculate a predicted value T of the passage time.

Note that the prediction unit 114 may calculate the predicted value T of the passage time using the following equation with a movement direction θ of the road user P:

$$T = L / ( v sin θ )$$

The message includes the real-time status for the pedestrian crossing 20. For example, the predicted value T is calculated using the real-time remaining passage distance L, the real-time velocity v of the road user P, and the real-time road user movement direction θ of the road user P. Thus, the accuracy of the predicted value T varies over time. For example, the predicted value T just before the road user P finishes crossing the pedestrian crossing 20 is more accurate than the predicted value T when the road user P starts crossing the pedestrian crossing 20.

A message may also include a predicted value of a passage completion time at which the road user P finishes crossing the pedestrian crossing 20.

Referring back to FIG. 3, the sudden event detection unit 115 detects the occurrence of a sudden event to a road user P. For example, a sudden event is an event that occurs while a road user P is crossing the pedestrian crossing 20, and makes it impossible or difficult for the road user P to cross the pedestrian crossing 20. A sudden event refers to a traffic accident, injury, fall, or seizure.

The sudden event detection unit 115 detects the occurrence of a sudden event in the pedestrian crossing area 501 when a road user P who is stationary or moving at a significantly low velocity is present, and the position of the road user P remains continuously unchanged for a certain period of time. Specifically, the sudden event detection unit 115 determines, from among road users P detected in the pedestrian crossing area 501, whether there is any road user whose movement velocity is a first threshold or less. If there is a road user whose movement velocity is the first threshold or less, the sudden event detection unit 115 refers to the detection results of this road user's past positions and, if the road user's position remains continuously unchanged for a second threshold or more, it detects the occurrence of a sudden event. Note that “the road user's position remain unchanged” here includes cases where the road user's movement distance is a certain reference value or less.

Sudden events may be events other than those that occur while a road user P is crossing the pedestrian crossing 20 and make it impossible or difficult for the road user P to cross the pedestrian crossing 20. For example, a sudden event is when the road user P ignores the signal. When multiple road users P are stationary in the standby areas 502A and 502B, if the sudden event detection unit 115 detects movement of some of the road users P to the pedestrian crossing area 501, it determines that the signal has been ignored and can detect the occurrence of a sudden event. As yet another example, a sudden event may be the dropping of a load from a truck, the passage of an emergency vehicle, or a traffic accident between vehicles or between a vehicle and a pedestrian. For example, the camera device 150 can detect, through image analysis, the dropping of a load from a truck, the passage of an emergency vehicle, or a traffic accident between vehicles or between a vehicle and a pedestrian, and notify the infrastructure radio wave sensor 100 of the detection result. The sudden event detection unit 115 can detect the occurrence of a sudden event based on a notification from the camera device 150.

The reliability determination unit 116 determines a first reliability, which is the reliability of the predicted value T of the passage time, and a second reliability, which is the reliability of the detection of the occurrence of a sudden event.

The reliability determination unit 116 determines the first reliability based on at least one of the velocity or acceleration of the road user P, an overlap between objects, the movement direction of the road user P, and a tracking time of the road user P in the infrastructure radio wave sensor 100 (a period of time during which the road user P is continuously tracked). For example, the reliability determination unit 116 sets the first reliability high when the movement velocity of a road user in the pedestrian crossing area 501 remains continuously unchanged for the second determination time or longer. Note that “the road user's movement velocity remains unchanged” here includes cases where the amount of change in the road user's movement velocity is a certain reference value or less. The reliability determination unit 116 can calculate the acceleration of a road user in the pedestrian crossing area 501 and, when the acceleration is a third threshold or more, it can set the first reliability low. Furthermore, as described above, as the road user P crossing the pedestrian crossing 20 approaches the end of the pedestrian crossing 20, i.e., the standby area 502B at his/her destination, the accuracy of the predicted value T increases. Therefore, for example, the reliability determination unit 116 may use the remaining passage distance L to determine the first reliability. Specifically, the reliability determination unit 116 can increase the first reliability as the remaining passage distance L becomes less.

In the pedestrian crossing area 501, the reliability determination unit 116 can set the first reliability low if a problem (occlusion) occurs that objects are not correctly detected due to an overlap between them. In an object tracking process, if an object whose position, velocity, and movement direction are close to those of an object, estimated from the position, velocity, and movement direction of object A detected at time T1, is not detected at time T2, then the estimated position, velocity, and movement direction are considered to be the position, velocity, and movement direction of object A at time T2. As mentioned here, if there is no detection result close to the estimated position, velocity, and movement direction for a certain period of time (hereinafter referred to as “disappearance”), the reliability determination unit 116 can determine that occlusion has occurred. The reliability determination unit 116 may set thresholds at two levels, T01 and T02 (T02>T01). If the disappearance time based on the position, velocity, and movement direction is between the first threshold T01 and the second threshold T02, the reliability determination unit 116 can set the first reliability low. If the disappearance time is the second threshold T02 or more, the reliability determination unit 116 can set the first reliability yet lower.

The reliability determination unit 116 can set the first reliability high when the tracking time of the road user P through the tracking process is a fourth threshold or more. The reliability determination unit 116 can calculate each variance value of the position and velocity of the tracked road user P. When the calculated variance value is a fifth threshold or more, the reliability determination unit 116 can set the first reliability low.

The reliability determination unit 116 determines the second reliability based on at least one of the time during which the road user P is stopped (stop time) and an image of the road user P captured by the camera 151. For example, the reliability determination unit 116 can set the second reliability high when the stop time of the road user P to which a sudden event has occurred is a sixth threshold or more. The sixth threshold is a value greater than the above-mentioned second threshold.

For example, the image processing circuit 152 of the camera device 150 detects a sudden event occurring to a road user P crossing the pedestrian crossing 20 by analyzing an image captured by the camera 151. The reliability determination unit 116 can set the second reliability high when the occurrence of a sudden event is detected by the sudden event detection unit 115 and also the occurrence of a sudden event is detected at the camera device 150.

The reliability determination unit 116 can generate numerical first reliability and second reliability values. The reliability determination unit 116 may generate the first reliability and the second reliability quantized into three levels, A, B, and C, for example.

The message creation unit 117 creates a message including the status obtained by at least one of the stopped vehicle detection unit 112, the counting unit 113, the prediction unit 114, the sudden event detection unit 115, and the reliability determination unit 116. For example, the message includes a header, static status, and dynamic status. The header includes the message transmission time, the time (delay time) from the object detection time (radio wave transmission time) to the message transmission time, the number of objects detected by the infrastructure radio wave sensor 100, and the size of the message. The static status includes the shape of the detection area 30 and the coordinates of the pedestrian crossing area 501 and the standby areas 502A and 502B in the detection area 30. The dynamic status includes the status obtained by at least one of the stopped vehicle detection unit 112, the counting unit 113, the prediction unit 114, the sudden event detection unit 115, and the reliability determination unit 116. The message created by the message creation unit 117 is output from the communication I/F 106 to an external device (e.g., control apparatus 11).

The message creation unit 117 can include the status of a stopped vehicle detected by the stopped vehicle detection unit 112 in the message. In the message, the presence or absence of a stopped vehicle can be represented by a specific one bit. That is, the message creation unit 117 can set 1 to the foregoing bit in the presence of a stopped vehicle, and set 0 to the foregoing bit in the absence of a stopped vehicle. By including the status of a stopped vehicle in the message, for example, in the absence of a stopped vehicle, the control apparatus 11 can control the pedestrian traffic light 10 to avoid shortening the permitted passage period (green light period). In the presence of a stopped vehicle, the control apparatus 11 can control the pedestrian traffic light 10 to shorten the permitted passage period.

The message creation unit 117 can include the number of passing vehicles in the pedestrian crossing area 501, counted by the counting unit 113, in the message. The message creation unit 117 can individually include in the message the number of vehicles that have passed through the pedestrian crossing area 501 in X1 direction and the number of vehicles that have passed through the pedestrian crossing area 501 in X2 direction, and can also include in the message the sum of the number of vehicles that have passed through the pedestrian crossing area 501 in X1 direction and the number of vehicles that have passed through the pedestrian crossing area 501 in X2 direction. By including the number of passing vehicles in the message, the number of passing vehicles can be used by the control apparatus 11 to control the pedestrian traffic light 10. For example, when the number of passing vehicles is small, the control apparatus 11 can control the pedestrian traffic light 10 to avoid shortening the permitted passage period. When the number of passing vehicles is large, the control apparatus 11 can control the pedestrian traffic light 10 to shorten the permitted passage period. Furthermore, the number of passing vehicles can also be used to control a vehicle traffic light (not illustrated).

The message creation unit 117 can include the predicted value T of the passage time of the road user P, calculated by the prediction unit 114, in the message. The control apparatus 11 can adjust the permitted passage period of the pedestrian traffic light 10 using the predicted value T of the passage time. The predicted value T is highly accurate because it is calculated using the Doppler velocity of the road user P detected by the infrastructure radio wave sensor 100. Therefore, the permitted passage period can be accurately ended with the completion of the road user P crossing the pedestrian crossing 20.

When the prediction unit 114 calculates predicted values T of passage times for multiple road users P, the message creation unit 117 can include all of these predicted values T in the message. The message creation unit 117 may include the minimum, maximum, or mean of the predicted values T of passage times for multiple road users P in the message. In this way, the size of the message can be reduced.

The message creation unit 117 can include the first reliability in the message. This allows the control apparatus 11 to use the first reliability in controlling the pedestrian traffic light. For example, if the first reliability is a set value or more, the control apparatus 11 can adjust the permitted passage period of the pedestrian traffic light 10 using the predicted value T of the passage time. In contrast, if the first reliability is below the set threshold, the control apparatus 11 can refrain from adjusting the permitted passage period of the pedestrian traffic light 10 using the predicted value T of the passage time.

The message creation unit 117 can include the occurrence status of a sudden event in the message. In the message, the presence or absence of a sudden event can be represented by a specific one bit. That is, the message creation unit 117 can set 1 to the foregoing bit if a sudden event is occurring, and set 0 to the foregoing bit if no sudden event is occurring. By including the occurrence status of a sudden event in the message, for example, the control apparatus 11 can control the pedestrian traffic light 10 to extend the permitted passage time in the occurrence of a sudden event.

The message creation unit 117 can include the second reliability in the message. This allows the control apparatus 11 to use the second reliability in controlling the pedestrian traffic light. For example, if the second reliability is a set value or more and a sudden event is occurring, the control apparatus 11 can control the pedestrian traffic light 10 to extend the permitted passage period by a first period. If the second reliability is less than the set value and a sudden event is occurring, the control apparatus 11 can control the pedestrian traffic light 10 to extend the permitted passage period by a second period that is shorter than the first period.

The message creation unit 117 may include statuses other than those mentioned above in the message. For example, the message creation unit 117 may include in the message the presence status or the number of road users P in the pedestrian crossing area 501, the presence status or the number of road users P in the standby area 502A, and the presence status or the number of road users P in the standby area 502B.

Using the message output from the infrastructure radio wave sensor 100, the control apparatus 11 can perform various types of control of the pedestrian traffic light 10 (as well as the vehicle traffic light). For example, if a stopped vehicle is present at the vehicle stop line 61 and no road users P are present in the pedestrian crossing area 501, and if the pedestrian traffic light 10 is green (while the vehicle traffic light is red), the vehicle V would be unnecessarily kept waiting. In this case, depending on the presence status of a stopped vehicle and of road users P in the pedestrian crossing area 501 in the message, it is recognized that a stopped vehicle is present at the vehicle stop line 61 and no road users P are present in the pedestrian crossing area 501, thereby enabling the control apparatus 11 to switch the pedestrian traffic light 10 from passage permitted to passage prohibited. This prevents the vehicle V from unnecessarily waiting for the signal and improves traffic convenience.

Furthermore, if the number of passing vehicles in the pedestrian crossing area 501 is a certain value or more and if no road users P are present in the standby areas 502A and 502B, for example, the control apparatus 11 can extend the prohibited passage period of the pedestrian traffic light 10 (the permitted passage period of the vehicle traffic light).

Accordingly, when there are no road users P crossing the pedestrian crossing 20, the pedestrian traffic light 10 does not hinder the traveling of the vehicle V, thereby improving traffic convenience. Furthermore, the control apparatus 11 can extend the permitted passage period of the pedestrian traffic light 10 during periods with fewer vehicles passing through the pedestrian crossing area 501, and shorten the permitted passage period of the pedestrian traffic light 10 during periods with more vehicles passing through the pedestrian crossing area 501. In this way, smooth traffic can be achieved by controlling the pedestrian traffic light 10 in accordance with the traffic volume of vehicles passing through the pedestrian crossing area 501.

### [1-3. Operation of Infrastructure Radio Wave Sensor]

The infrastructure radio wave sensor 100 can execute an object detection process, a tracking process, a stopped vehicle detection process, a vehicle counting process, a passage time prediction process, a sudden event detection process, a first reliability determination process, a second reliability determination process, and a message creation process as described below by activating the analysis program 108 by the processor 101. The processor 101 repeatedly executes the object detection process, the stopped vehicle detection process, the vehicle counting process, the passage time prediction process, the sudden event detection process, the first reliability determination process, the second reliability determination process, and the message creation process at regular intervals.

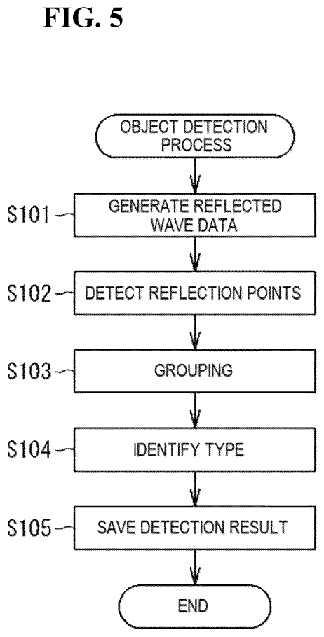

FIG. 5 is a flowchart illustrating an example of the object detection process.

The processor 101 controls the transmission circuit 104 and the reception circuit 105. Accordingly, modulated waves are transmitted from the transmission antenna 104a, and reflected waves are received by the reception antenna 105a. The processor 101 combines a modulated wave signal output from the transmission circuit 104 with a reflected wave signal output from the reception circuit 105 to generate an IF signal. The processor 101 obtains distance, velocity, and azimuth angle by performing signal processing such as FFT on the IF signal, and generates reflected wave data (step S101).

The processor 101 analyzes the reflected wave data and detects reflection points (peak points) (step S102). The processor 101 groups together the reflection points from the same object (step S103).

The processor 101 identifies the type of the detected object (road user or vehicle) (step S104). The processor 101 saves the detection result, i.e., the object's type and position (distance and azimuth angle), as well as its velocity, in the non-volatile memory 102 (step S105). At this point, the object detection process ends.

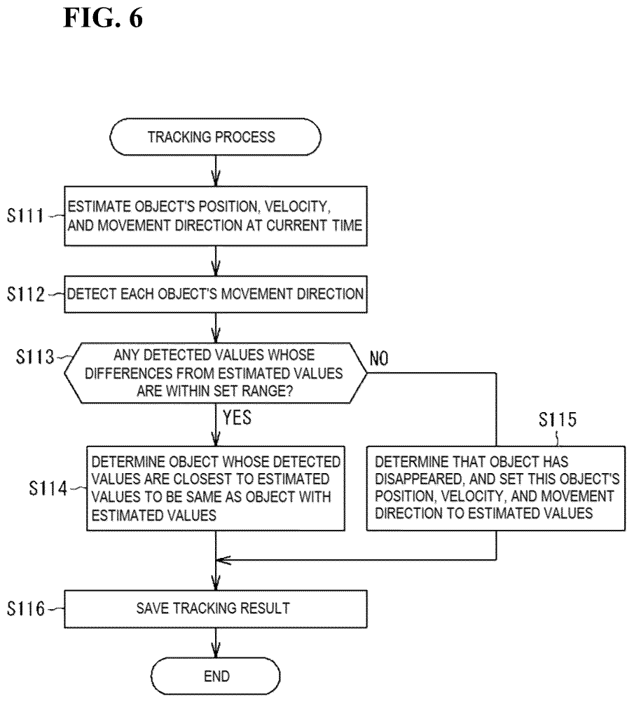

FIG. 6 is a flowchart illustrating an example of the tracking process.

The processor 101 estimates each object's current position, velocity, and movement direction based on the results of the past tracking process (step S111). The processor 101 detects the current movement direction of each object based on the object's chronological positions detected by the object detection process (step S112). The processor 101 compares each object's current position, velocity, and movement direction (hereinafter also referred to as the “detected values”) with the estimated position, velocity, and movement direction (hereinafter also referred to as the “estimated values”), and determines whether there are any detected values whose differences from the estimated values are within a given set range (step S113).

If there are detected values whose differences from the estimated values are within the set range (YES in step S113), the processor 101 determines that the object with the detected values closest to the estimated values is the same as the object with the estimated values (step S114). In contrast, if there are no detected values whose differences from the estimated values are within the set range (NO in step S113), the processor 101 determines that the object has disappeared and sets the object's position, velocity, and movement direction to the estimated values (step S115).

After step S114 or S115, the processor 101 saves the tracking result in the non-volatile memory 102 (step S116). At this point, the tracking process ends.

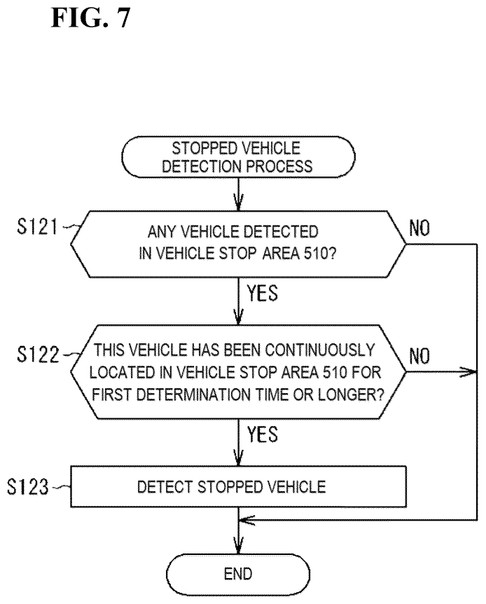

FIG. 7 is a flowchart illustrating an example of the stopped vehicle detection process.

The processor 101 refers to the detection result of the object detection process and determines whether a vehicle V has been detected in the vehicle stop area 510 (step S121). If no vehicle V has been detected in the vehicle stop area 510 (NO in step S121), the stopped vehicle detection process ends.

If a vehicle V has been detected in the vehicle stop area 510 (YES in step S121), the processor 101 refers to the results of the tracking process and determines whether the vehicle V has been continuously located in the vehicle stop area 510 for the first determination time or longer (step S122). If the vehicle V has not been continuously located in the vehicle stop area 510 for the first determination time or longer (NO in step S122), the processor 101 ends the stopped vehicle detection process.

If the vehicle V has been continuously located in the vehicle stop area 510 for the first determination time or longer (YES in step S122), the processor 101 determines that the vehicle Vis a stopped vehicle (step S123). At this point, the processor 101 ends the stopped vehicle detection process.

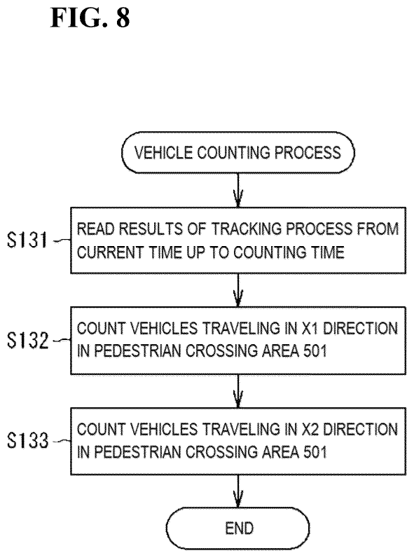

FIG. 8 is a flowchart illustrating an example of the vehicle counting process.

The processor 101 reads from the non-volatile memory 102 the results of the tracking process from the current time up to a previously set counting time (step S131).

The processor 101 refers to the read-out tracking process results and counts vehicles V traveling in X1 direction in the pedestrian crossing area 501 (step S132). Furthermore, the processor 101 refers to the read-out tracking process results and counts vehicles V traveling in X2 direction in the pedestrian crossing area 501 (step S133). At this point, the processor 101 ends the vehicle counting process.

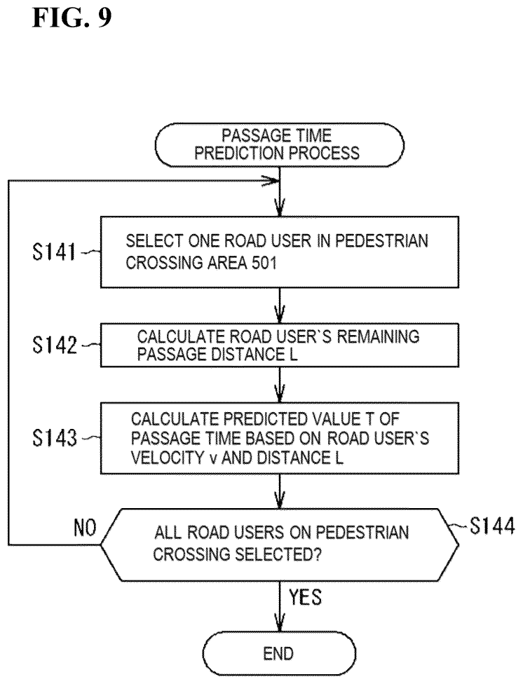

FIG. 9 is a flowchart illustrating an example of the passage time prediction process.

The processor 101 refers to the results of the object detection process and selects one road user in the pedestrian crossing area 501 (step S141).

The processor 101 calculates the remaining passage distance L of the selected road user P (step S142). The processor 101 divides the calculated remaining passage distance L by the velocity v of the selected road user P to calculate the predicted value T of the passage time (step S143).

The processor 101 determines whether all road users in the pedestrian crossing area 501 have been selected (step S144). If there remains one or more unselected road users among the road users in the pedestrian crossing area 501 (NO in step S144), the processor 101 returns to step S141 to select a new road user from among the unselected road users (step S141). If all road users in the pedestrian crossing area 501 have been selected (NO in step S144), the processor 101 ends the passage time prediction process.

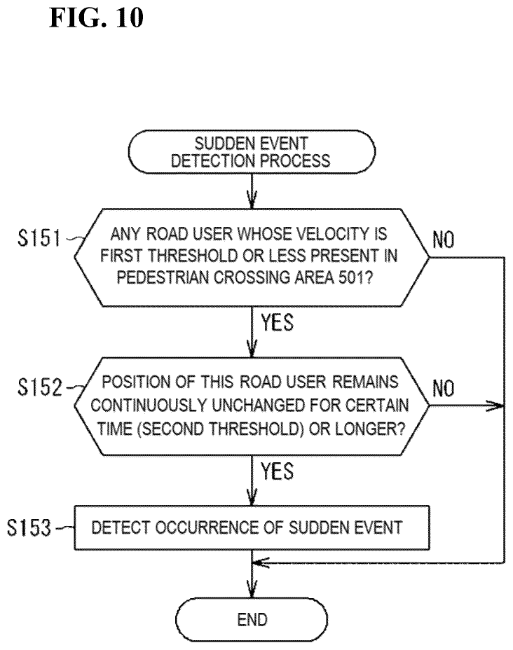

FIG. 10 is a flowchart illustrating an example of the sudden event detection process.

The processor 101 determines whether a road user P whose velocity is the first threshold or less is present in the pedestrian crossing area 501 (step S151). If no road user P whose velocity is the first threshold or less is present in the pedestrian crossing area 501 (NO in step S151), the processor 101 ends the sudden event detection process.

If a road user P whose velocity is the first threshold or less is present in the pedestrian crossing area 501 (YES in step S151), the processor 101 refers to the results of the tracking process and determines whether the position of the road user P remains continuously unchanged for a certain period of time (second threshold) or more, i.e., whether the period of time during which the position of the road user P remains unchanged is the second threshold or more (step S152). If the period of time during which the position of the road user P remains unchanged is less than the second threshold (NO in step S152), the processor 101 ends the sudden event detection process.

If the period of time during which the position of the road user P remains unchanged is the second threshold or more (YES in step S152), the processor 101 determines that a sudden event has occurred to the road user P and detects the occurrence of the sudden event (step S153). At this point, the processor 101 ends the sudden event detection process.

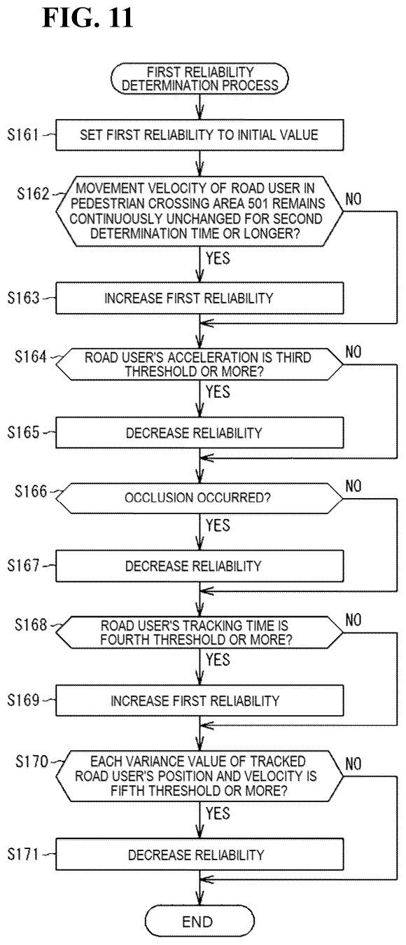

FIG. 11 is a flowchart illustrating an example of the first reliability determination process.

The processor 101 sets the first reliability to an initial value (step S161).

The processor 101 then refers to the results of the tracking process and determines whether the movement velocity of the road user P in the pedestrian crossing area 501 remains continuously unchanged for the second determination time or longer, that is, whether the period of time during which the movement velocity of the road user P in the pedestrian crossing area 501 remains unchanged is the second determination time or longer (step S162).

If the period of time during which the movement velocity of the road user P in the pedestrian crossing area 501 remains unchanged is the second determination time or longer (YES in step S162), the processor 101 increases the first reliability by a certain value (step S163) and moves to step S164. In contrast, if the period of time during which the movement velocity of the road user P in the pedestrian crossing area 501 remains unchanged is less than the second determination time (NO in step S162), the processor 101 moves to step S164 without changing the first reliability.

The processor 101 determines whether the acceleration of the road user P in the pedestrian crossing area 501 is the third threshold or more (step S164). If the acceleration of the road user P in the pedestrian crossing area 501 is the third threshold or more (YES in step S164), the processor 101 decreases the first reliability by a certain value (step S165) and moves to step S166. In contrast, if the acceleration of the road user P in the pedestrian crossing area 501 is less than the third threshold (NO in step S164), the processor 101 moves to step S166 without changing the first reliability.

The processor 101 refers to the results of the tracking process and determines whether occlusion has occurred by determining whether there is an object that has disappeared for a certain period of time or longer (step S166). If occlusion has occurred (YES in step S166), the processor 101 decreases the first reliability by a certain value (step S167) and moves to step S168. In contrast, if no occlusion has occurred (NO in step S166), the processor 101 moves to step S168 without changing the first reliability.

The processor 101 refers to the results of the tracking process and determines whether the tracking time for each road user P detected in the pedestrian crossing area 501 is the fourth threshold or more (step S168). If the tracking time of each road user P is the fourth threshold or more (YES in step S168), the processor 101 increases the first reliability by a certain value (step S169) and moves to step S170. In contrast, if the tracking time of at least one road user P is less than the fourth threshold (NO in step S168), the processor 101 moves to step S170 without changing the first reliability.

From the results of the tracking process, the processor 101 calculates each variance value of the position and velocity of each road user P detected in the pedestrian crossing area 501, and determines whether each variance value of the position and velocity of each road user P is the fifth threshold or more (step S170). If each variance value of the position and velocity of each road user P is the fifth threshold or more (YES in step S170), the processor 101 decreases the first reliability by a certain value (step S171). In contrast, if each variance value of the position or velocity of at least one road user P is less than the fifth threshold (NO in step S170), the processor 101 does not change the first reliability. At this point, the processor 101 ends the first reliability determination process.

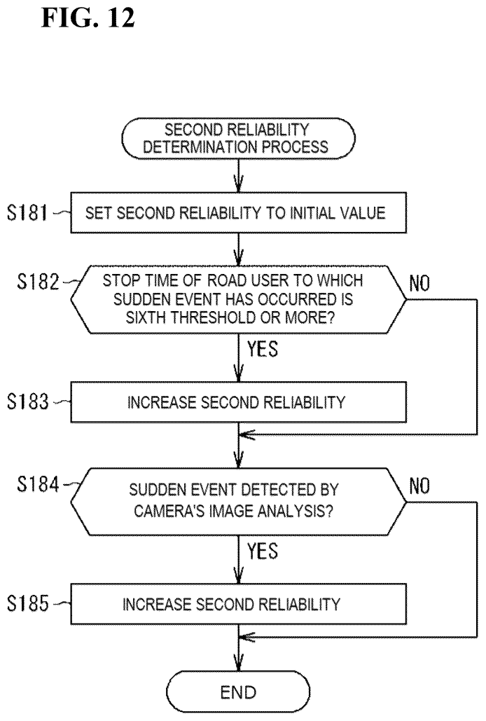

FIG. 12 is a flowchart illustrating an example of the second reliability determination process.

The processor 101 sets the second reliability to an initial value (step S181).

The processor 101 then refers to the results of the tracking process and determines whether the stop time of a road user P to which the occurrence of a sudden event has been detected is the sixth threshold or more (step S182). If the stop time of the road user P is the sixth threshold or more (YES in step S182), the processor 101 increases the second reliability by a certain value (step S183) and moves to step S184.

In contrast, if the stop time of the road user P is less than the sixth threshold (NO in step S182), the processor 101 moves to step S184 without changing the second reliability.

The processor 101 refers to the image analysis result input from the camera device 150 and determines whether the occurrence of a sudden event has been detected at the camera device 150 (step S184). If the occurrence of a sudden event has been detected at the camera device 150 (YES in step S184), the processor 101 increases the second reliability by a certain value (step S185). In contrast, if the occurrence of a sudden event has not been detected at the camera device 150 (NO in step S184), the processor 101 does not change the second reliability. At this point, the processor 101 ends the second reliability determination process.

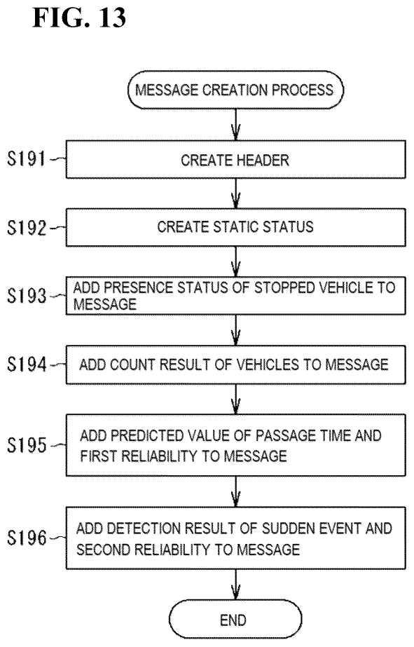

FIG. 13 is a flowchart illustrating an example of the message creation process.

The processor 101 creates a header for a message (step S191) and creates static status (step S192).

The processor 101 then creates dynamic status for the message. First, the processor 101 adds the presence status of a stopped vehicle to the message (step S193). The processor 101 then adds the count result of vehicles passing through the pedestrian crossing area 501 to the message (step S194). The processor 101 adds the predicted value T of the passage time and the first reliability to the message (step S195), and adds the detection result of a sudden event and the second reliability to the message (step S196). At this point, the processor 101 ends the message creation process.

The communication I/F 106 outputs the created message.

### 2. Second Embodiment

### [2-1. Configuration of Infrastructure Radio Wave Sensor]

The configuration of an infrastructure radio wave sensor according to a second embodiment is similar to the configuration of the infrastructure radio wave sensor according to the first embodiment, and hence the same components are denoted by the same reference numerals and their descriptions are omitted.

### [2-2. Functions of Infrastructure Radio Wave Sensor]

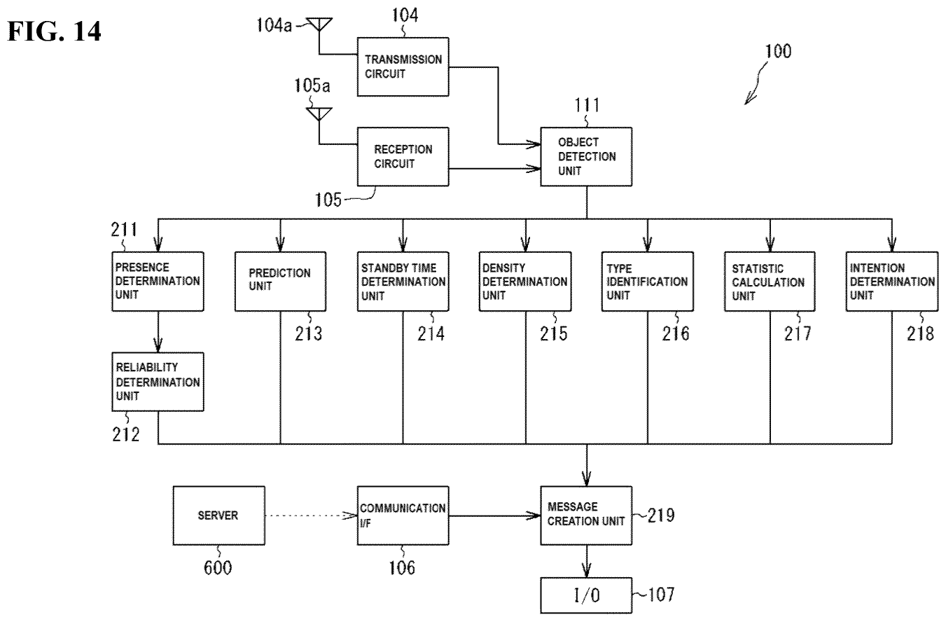

FIG. 14 is a functional block diagram illustrating an example of functions of the infrastructure radio wave sensor 100 according to the second embodiment. By executing the analysis program 108, the processor 101 implements the functions of the object detection unit 111, a presence determination unit 211, a reliability determination unit 212, a prediction unit 213, a standby time determination unit 214, a density determination unit 215, a type identification unit 216, a statistic calculation unit 217, an intention determination unit 218, and a message creation unit 219.

The object detection unit 111 is the same as the object detection unit 111 in the first embodiment, and hence its description is omitted.

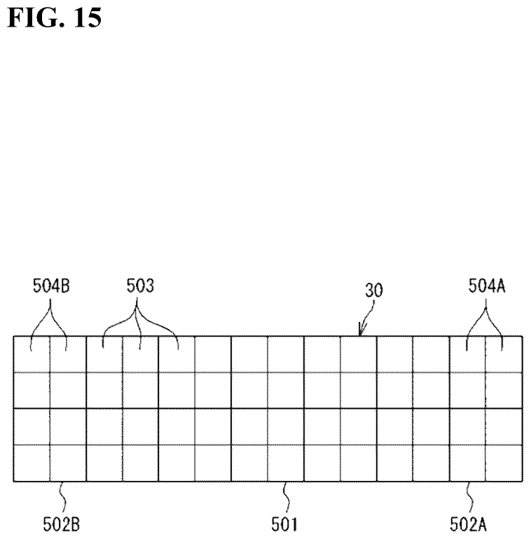

The infrastructure radio wave sensor 100 according to the second embodiment creates a message including the detection results of road users P in each of multiple divided areas (hereinafter referred to as “cells”) into which the detection area 30 is divided, and outputs the created message. FIG. 15 is a diagram for explaining cells. The pedestrian crossing area 501 includes multiple cells 503. The standby area 502A includes multiple cells 504A. The standby area 502B includes multiple cells 504B. As illustrated in FIG. 15, the cells 503 are rectangular areas smaller than the pedestrian crossing area 501. The cells 504A are rectangular areas smaller than the standby area 502A. The cells 504B are rectangular areas smaller than the standby area 502B. For example, the cells 503, 504A, and 504B are areas of the same shape and the same size. The cells 503, 504A, and 504B may be set to any shape and size. The cells 503, 504A, and 504B are each assigned a cell ID.

The cells 503, 504A, and 504B are set to at least a size that accommodates one person, or a size that is at least the maximum resolution of the infrastructure radio wave sensor 100.

The presence determination unit 211 determines whether road users are present in each of the cells 503, 504A, and 504B. If the detected position of one or more road users P is included within the cells 503, 504A, and 504B, the presence determination unit 211 determines that the road users P are present in the corresponding cells 503, 504A, and 504B. If the detected position of road users P is not included within the cells 503, 504A, and 504B, the presence determination unit 211 determines that no road users P are present in the corresponding cells 503, 504A, and 504B

If a road user P is present in any of the cells 503, 504A, and 504B, the presence determination unit 211 determines the movement direction of the road user P. For example, the presence determination unit 211 determines whether the movement direction of the road user P present in any of the cells 503, 504A, and 504B is either X1 or X2. The presence determination unit 211 generates the presence status of road users P for each of the cells 503, 504A, and 504B. The presence status indicates whether road users P are present, and if so, the movement direction of the road users P. Note that the movement direction may be not only in the two directions X1 and X2, but also in the four directions X1, X2, Y1, and Y2, or in eight directions additionally including the four diagonal directions.

If a road user P is present in any of the cells 504A and 504B of the standby areas 502A and 502B, the presence determination unit 211 may determine whether the road user P is stationary using the results of the tracking process, and, if so, may add the stop status to the presence status. The presence determination unit 211 may determine that the road user P is stationary, for example, when the velocity of the road user P is less than v1 (km/h) and the road user P has been present in the standby area 502A or 502B for S seconds or more. Furthermore, the presence determination unit 211 may cancel the determination of a road user P being stationary if at least one of the following two conditions is met: condition 1) the velocity of the road user P is v2 (km/h) or more for P seconds or more; and condition 2) the road user P has moved R (m) or more from the stationary position.

In the case where it is unclear whether a road user P is present in a certain cell, the presence determination unit 211 may generate a status indicating the uncertainty. The case where it is unclear whether a road user P is present in a cell refers to, for example, the case where a road user P disappears within a certain period of time in the tracking process.

The reliability determination unit 212 determines a third reliability, which is the reliability of the presence status, for each of the cells 503, 504A, and 504B. The reliability determination unit 212 calculates the variance value of the position of the road user P.

The reliability determination unit 212 may calculate the variance value of the velocity of the road user P instead of the variance value of the position of the road user P. The reliability determination unit 212 can determine the third reliability in accordance with the calculated variance value. That is, the reliability determination unit 212 can set the third reliability high when the variance value is small, and set the third reliability when the variance value is large.

The reliability determination unit 212 can detect the occurrence of occlusion for each of the cells 503, 504A, and 504B. The reliability determination unit 212 can set the third reliability low when the occurrence of occlusion is detected, and set the third reliability high when the occurrence of occlusion is not detected.

The reliability determination unit 212 may calculate, for each of the cells 503, 504A, and 504B, a tracking time for which road users P have been tracked in the tracking process. The reliability determination unit 212 can set the third reliability high when the tracking time is long, and set the third reliability low when the tracking time is short.

The reliability determination unit 212 may change the method of determining the third reliability on a cell-by-cell basis. For example, if a road user P is waiting in the standby area 502B of the pedestrian crossing 20, from the infrastructure radio wave sensor 100, occlusion occurs due to a vehicle V traveling on the roadway 60. Thus, if the third reliability is set based on whether occlusion has occurred or not, the third reliability will always be low. Therefore, the reliability determination unit 212 may utilize the tracking time in preference to the occurrence of occlusion for the cells 504B of the standby area 502B (e.g., utilizes the tracking time without utilizing the occurrence of occlusion) to determine the third reliability. In this way, the accuracy of the third reliability can be improved. In contrast, because occlusion is less likely to occur in the standby area 502A, the reliability determination unit 212 can preferentially utilize the occurrence of occlusion to determine the third reliability.

The reliability determination unit 212 may calculate a likelihood 1 using the following equation and determine the third reliability based on the likelihood 1. In the following equation, Z is the observation value from the infrastructure radio wave sensor 100, Zpre is the predicted observation value calculated by the tracking process, and S is the error covariance matrix.

$$l = \frac{1}{\sqrt{2 π} \vert S \vert} exp [ - \frac{1}{2} {\tilde{z}}^{T} {S}^{- 1} \tilde{z} ] \qquad [ Equation 1 ]$$

$$\tilde{z} = z - {z}_{pre}$$

The reliability determination unit 212 can store the basis for calculating the third reliability along with the third reliability in the non-volatile memory 102. The basis is as follows, for example.

(Example 1) In the case where the third reliability is set low because the detected position of the road user P is unstable, the dispersion value of the position of the road user P.
(Example 2) In the case where the third reliability is set low due to the occurrence of occlusion for a certain time TO or more, the occurrence time of the occlusion.
(Example 3) In the case where the third threshold is set low due to the likelihood 1 being a threshold J or less, the likelihood 1.

Such basis mentioned above can be utilized to optimize the signal switching timing during maintenance of the pedestrian traffic light 10. For example, in the case where the pedestrian crossing 20 has a high frequency of occurrence of occlusion in the daytime and a high dispersion value of the detected position (or velocity), the maintenance worker can grasp such status by referring to the basis and set a longer permitted passage period in the daytime (e.g., from 10:00 to 14:00) for the pedestrian traffic light 10.

The prediction unit 213 predicts the passage time of a road user P crossing the pedestrian crossing 20 for each of the cells 503, 504A, and 504B. The method for predicting the passage time by the prediction unit 213 is the same as or similar to the method for predicting the passage time by the prediction unit 114 in the first embodiment.

The standby time determination unit 214 determines the time a road user P waits for the signal (standby time) for each of the cells 504A and 504B of the standby areas 502A and 502B. The standby time determination unit 214 refers to the results of the tracking process to identify the time the road user P is located in the standby area 502A or 502B, and regards the identified time as the standby time.

The density determination unit 215 determines the density of road users P for each of the cells 503, 504A, and 504B. In a specific example, the density is the number of road users P present in each of the cells 503, 504A, and 504B. The density determination unit 215 can refer to the detection results obtained by the object detection unit 111 to count the number of road users P located in each of the cells 503, 504A, and 504B, and regard the counted number of road users P as the density. In another example, the cells 503, 504A, and 504B are divided into ten smaller areas, and the density determination unit 215 determines whether road users P are present in each of these smaller areas. The density determination unit 215 may count the number x of smaller areas where road users P are present, and calculate the density D using density D=x/10*100(%).

The type identification unit 216 identifies the type of road users P present for each of the cells 503, 504A, and 504B. The types include vulnerable road users and road users who are not vulnerable road users (hereinafter referred to as “general road users”). Vulnerable road users include children, the elderly, and people with disabilities. The type identification unit 216 can identify vulnerable road users using a trained model configured by machine learning.

For example, the input data of the trained model includes the results of the tracking process (chronological data of the movement trajectory of road users P), and the output data of the trained model includes types indicating whether the road users P are vulnerable road users or general road users.

The type identification unit 216 may identify whether each road user is a pedestrian or a cyclist. The identification may use a trained model. Furthermore, the image processing circuit 152 in the camera device 150 may identify the type of road user (pedestrian or cyclist, vulnerable road user or general road user) based on the image and output the identification result. The type identification unit 216 may determine the type of road user using the type identification result obtained by the trained model and the type identification result obtained by the camera device 150. For example, when the type identification result obtained by the trained model matches the type identification result obtained by the camera device 150, the type identification unit 216 can determine the identified type as the type.

For example, when the type identification result obtained by the trained model does not match the type identification result obtained by the camera device 150, the type identification unit 216 can discard the type identification results.

The statistic calculation unit 217 calculates statistics for a previously set period (hereinafter referred to as a “target period”) for each of the cells 503, 504A, and 504B. The target period is set, for example, in hours, weeks, and days of the week. The statistic calculation unit 217 can refer to the results of the tracking process and calculate the number of road users detected in a single cell during the target period. The statistic calculation unit 217 can refer to the results of the tracking process and calculate a total time road users are detected in a single cell during the target period. The statistic calculation unit 217 can refer to the results of the tracking process and calculate the number of road users per movement direction detected in a single cell during the target period. For example, the statistic calculation unit 217 can calculate the number of road users P detected in a single cell during the target period, separately for those with the movement direction being Y1 and those with the movement direction being Y2.

In addition to the number of road users P in each cell during the target period, or instead of the number of road users P in each cell during the target period, the statistic calculation unit 217 may calculate the presence time the road users P are present for each of the cells 503, 504A, and 504B as a statistic.

The intention determination unit 218 determines whether road users P have the intention (hereinafter referred to as the “crossing intention”) to cross the pedestrian crossing 20 for each of the cells 504A and 504B of the standby areas 502A and 502B. The intention determination unit 218 can determine whether road users P have the crossing intention using a trained model configured by machine learning. For example, the input data of the trained model includes the results of the tracking process (chronological data of the movement trajectory of road users P), and the output data of the trained model includes the intention indicating whether the road users P have the crossing intention.

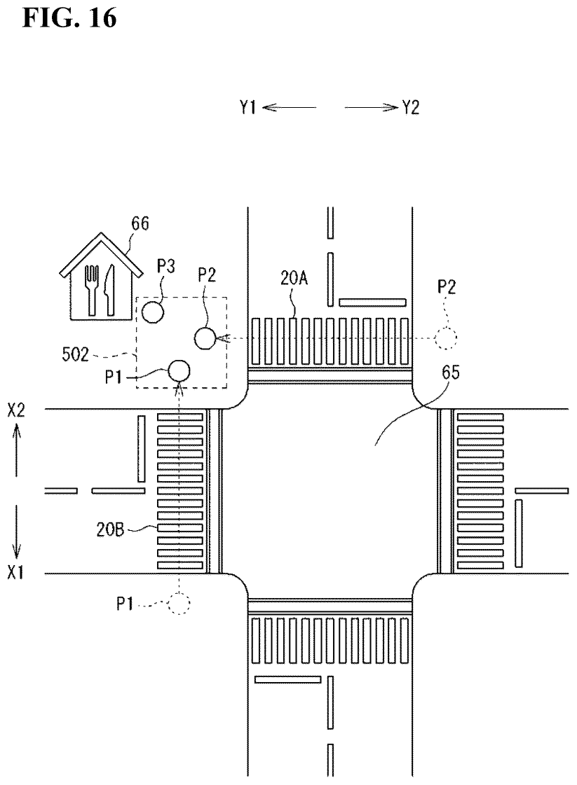

FIG. 16 is a diagram for explaining an example of the determination of a crossing intention. Referring to FIG. 16, the determination of the intention of passengers P1, P2, and P3 to cross a pedestrian crossing 20A provided at an intersection 65 will be described. The intersection 65 is provided with the pedestrian crossing 20A for crossing in Y1 and Y2 directions, and a pedestrian crossing 20B for crossing in X1 and X2 directions. A standby area 502 is adjacent to the pedestrian crossing 20A and is also adjacent to the pedestrian crossing 20B. The standby area 502 serves as an area for waiting for the signal at the pedestrian crossing 20A, as well as an area for waiting for the signal at the pedestrian crossing 20B.

The road user P1 crosses the pedestrian crossing 20B in X2 direction, and after finishing crossing the pedestrian crossing 20B, stops in the standby area 502. In this case, it is likely that the road user P1 intends to cross the pedestrian crossing 20A in Y2 direction and is waiting for the signal. Therefore, the intention determination unit 218 can determine that the road user P1 intends to cross the pedestrian crossing 20A.

The road user P2 crosses the pedestrian crossing 20A in Y1 direction, and after finishes crossing the pedestrian crossing 20A, stops in the standby area 502. In this case, it is likely that the road user P2 intends to cross the pedestrian crossing 20B in X1 direction and is waiting for the signal. Therefore, the intention determination unit 218 can determine that the road user P2 has no intention to cross the pedestrian crossing 20A.

The road user P3 is stationary within the standby area 502 and is located in the vicinity of a restaurant 66. In this case, it is likely that the road user P2 intends to enter the restaurant 66, and is unlikely to cross the pedestrian crossings 20A and 20B. Therefore, the intention determination unit 218 can determine that the road user P3 has no intention to cross the pedestrian crossing 20A.

Referring back to FIG. 14, the message creation unit 219 creates a message including the status obtained by at least one of the presence determination unit 211, the reliability determination unit 212, the prediction unit 213, the standby time determination unit 214, the density determination unit 215, the type identification unit 216, the statistic calculation unit 217, and the intention determination unit 218. The dynamic status of the message includes the status obtained by at least one of the presence determination unit 211, the reliability determination unit 212, the prediction unit 213, the standby time determination unit 214, the density determination unit 215, the type identification unit 216, the statistic calculation unit 217, and the intention determination unit 218. The message created by the message creation unit 117 is output from the communication I/F 106 to an external device (e.g., control apparatus 11).

The message creation unit 219 can include the presence status generated by the presence determination unit 211 in the message. In the message, the presence status can be represented by specific three bits. For example, whether road users P are present in the cells 503, 504A, and 504B is represented by one of the three bits. That is, the message creation unit 219 can set 1 to the foregoing bit if road users P are present in the cells 503, 504A, and 504B, and set 0 to the foregoing bit if no road users P are present. For example, the message creation unit 219 represents the movement direction of a road user P by two of the three bits. That is, the message creation unit 219 can set 01 to the two bits if the movement direction of the road user P in any of the cells 503, 504A, and 504B is Y1, and set 10 to the two bits if the movement direction is Y2. Furthermore, if there are two or more road users P in any of the cells 503, 504A, and 504B, with at least one of the road users P moving in direction Y1 and others in direction Y2, the message creation unit 219 can set 11 to the two bits. By including the presence status in the message, for example, if road users P are present in one or more cells 503 of the pedestrian crossing area 501, the control apparatus 11 can control the pedestrian traffic light 10 to extend the permitted passage period, and if no road users P are present in all of the cells 503 of the pedestrian crossing area 501, the control apparatus 11 can control the pedestrian traffic light 10 to shorten the permitted passage period. For example, if road users P are present in at least one of the cells 504A and 504B of the standby areas 502A and 502B, the control apparatus 11 can control the pedestrian traffic light 10 to switch from the prohibited passage period (red light period) to the permitted passage period.

The message creation unit 219 can include the third reliability in the message. This allows the control apparatus 11 to use the third reliability in controlling the pedestrian traffic light 10. For example, if the third reliability is a set value or more, the control apparatus 11 can control the pedestrian traffic light 10 using the presence status as mentioned above. In contrast, if the third reliability is less than the set value, the control apparatus 11 can, for example, delay the timing for switching the pedestrian traffic light 10 from passage prohibited to passage permitted, or control the pedestrian traffic light 10 without using the presence status.

The message creation unit 219 can include the basis for calculating the third reliability in the message. This allows the user to check on what basis the third reliability has been calculated. As mentioned earlier, the basis can be utilized to optimize the signal switching timing during maintenance of the pedestrian traffic light 10.

The message creation unit 219 may include the logical OR of the presence status in multiple cells 503, 504A, and 504B in the message. For example, the message creation unit 219 can calculate the logical OR of the presence status in the entire detection area 30 and include the calculated logical OR in the message. In another example, the message creation unit 219 can calculate the logical OR of the presence status in the pedestrian crossing area 501, the logical OR of the presence status in the standby area 502A, and the logical OR of the presence status in the standby area 502B, and include the calculated logical ORs in the message. This can reduce the size of the message, suppress the communication delay of the message, and prevent an increase in the processing time of the control apparatus 11 to control the pedestrian traffic light 10.

The message creation unit 219 can include in the message the predicted value T of the passage time of each road user P calculated for each cell by the prediction unit 213. For example, the control apparatus 11 can adjust the permitted passage period of the pedestrian traffic light 10 using the maximum value among the predicted values T of the passage times.

The predicted value T is highly accurate because it is calculated using the Doppler velocity of the road user P detected by the infrastructure radio wave sensor 100. Therefore, the permitted passage period can be accurately ended with the completion of the road user P crossing the pedestrian crossing 20.

The message creation unit 219 can include in the message the standby time determined for each of the cells 504A and 504B of the standby areas 502A and 502B. For example, the control apparatus 11 can determine that there is a road user P waiting for a long time if the maximum value among the standby times is a set value or more, and switch the pedestrian traffic light 10 from passage prohibited (red light) to passage permitted (green light). For example, the control apparatus 11 can determine that there is a road user P waiting for the signal if the maximum value among the standby times is less than the set value, and after a certain period of time, switch the pedestrian traffic light 10 from passage prohibited to passage permitted.

The message creation unit 219 can include in the message the density of road users P determined for each of the cells 503, 504A, and 504B. For example, the control apparatus 11 can control the pedestrian traffic light 10 using the density and standby time. Specifically, the control apparatus 11 can adjust the timing for switching the pedestrian traffic light 10 from passage prohibited to passage permitted in accordance with the result of multiplying the density and the standby time in one of the cells 504A and 504B of the standby areas 502A and 502B.

The message creation unit 219 can include the type generated by the type identification unit 216 in the message. The control apparatus 11 can extend the permitted passage period of the pedestrian traffic light 10 in the presence of a vulnerable road user in any of the cells 503 of the pedestrian crossing area 501. The control apparatus 11 can adjust the timing for switching the pedestrian traffic light 10 from passage prohibited to passage permitted depending on whether there are vulnerable road users in the cells 504A and 504B of the standby area 502A and 502B.

The message creation unit 219 can include in the message the statistics for each of the cells 503, 504A, and 504B calculated by the statistic calculation unit 217. Using the statistics, the control apparatus 11 can adjust the permitted passage period of the pedestrian traffic light 10 during periods with more road users or periods with fewer road users crossing the pedestrian crossing 20. Furthermore, the message may be sent to a server 600 at a traffic control center. The traffic control center can monitor the road user flow by time of the day and day of the week using the statistics included in messages, and adjust the timing for switching the pedestrian traffic light 10 between passage permitted and passage prohibited.

The message creation unit 219 can include the intention generated by the intention determination unit 218 in the message. In the case where the intention in any of the cells 504A and 504B of the standby areas 502A and 502B indicates that a road user P located in that cell intends to cross the pedestrian crossing 20, the control apparatus 11 can hasten the timing for switching the pedestrian traffic light 10 from passage prohibited to passage permitted.

### [2-3. Operation of Infrastructure Radio Wave Sensor]

The infrastructure radio wave sensor 100 can execute an object detection process, a tracking process, a presence determination process, a passage time prediction process, a third reliability determination process, a standby time determination process, a density determination process, a type identification process, a statistic calculation process, a crossing intention determination process, and a message creation process by activating the analysis program 108 by the processor 101. The processor 101 repeatedly executes the object detection process, the tracking process, the presence determination process, the passage time prediction process, the third reliability determination process, the standby time determination process, the density determination process, the type identification process, the statistic calculation process, the crossing intention determination process, and the message creation process at regular intervals. Note that the object detection process and the tracking process are the same as or similar to the object detection process and the tracking process described in the first embodiment, and hence their descriptions are omitted.

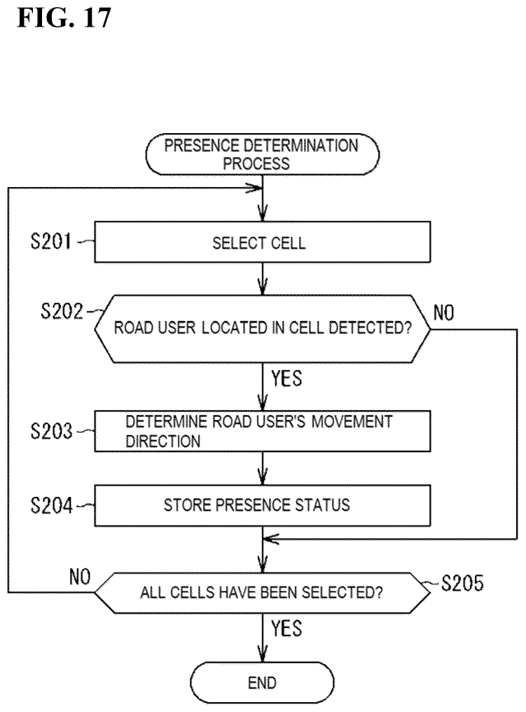

FIG. 17 is a flowchart illustrating an example of the presence determination process.

The processor 101 selects one of the cells 503, 504A, and 504B (step S201). The processor 101 refers to the detection results of the object detection process and determines whether a road user P located in the selected cell has been detected (step S202). If no road user P located in the selected cell has been detected (NO in step S202), the processor 101 moves to step S205.

If a road user P located in the selected cell has been detected (YES in step S202), the processor 101 refers to the results of the tracking process and determines the movement direction of the detected road user P (step S203). Furthermore, the processor 101 saves, in the non-volatile memory 102, the presence status indicating the fact that the road user P is present and the movement direction of the road user P in association with the cell ID of the selected cell (step S204).

The processor 101 determines whether all of the cells 503, 504A, and 504B have been selected (step S205). If unselected cells remain in the cells 503, 504A, and 504B (NO in step S205), the processor 101 returns to step S201 and selects a new cell from among the unselected cells (step S201). If all of the cells 503, 504A, and 504B have been selected (YES in step S205), the processor 101 ends the presence determination process.

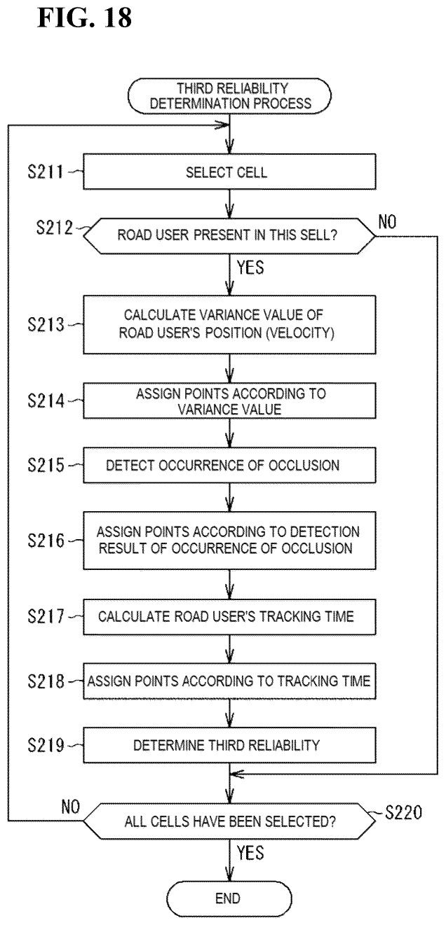

FIG. 18 is a flowchart illustrating an example of the third reliability determination process.

The processor 101 selects one of the cells 503, 504A, and 504B (step S211). The processor 101 refers to the presence status and determines whether a road user P is present in the selected cell (step S212). If no road user P is present in the selected cell (NO in step S212), the processor 101 moves to step S220.

If a road user P is present in the selected cell (YES in step S212), the processor 101 refers to the results of the tracking process and calculates the variance value of the position (or velocity) of the road user in the selected cell (step S213). The processor 101 assigns points to the selected cell in accordance with the variance value (step S214). The smaller the variance value, the higher the points assigned; the greater the variance value, the lower the points assigned.

The processor 101 refers to the results of the tracking process and detects the occurrence of occlusion in the selected cell (step S215). The processor 101 assigns points to the selected cell in accordance with the occlusion detection result (whether the occurrence of occlusion has been detected) (step S216). In the case where the occurrence of occlusion has not been detected, higher points are assigned; in the case where the occurrence of occlusion has been detected, lower points are assigned.

The processor 101 refers to the results of the tracking process and calculates the tracking time of the road user P in the selected cell (step S217). The processor 101 assigns points to the selected cell in accordance with the tracking time (step S218). The longer the tracking time, the higher the points assigned; the shorter the tracking time, the lower the points assigned.

The processor 101 determines the third reliability in accordance with the points assigned to the cell (step S219). The third reliability is set high when the points are high, and is set low when the points are low. The third reliability may be the sum of the points assigned to the cell.

The processor 101 determines whether all of the cells 503, 504A, and 504B have been selected (step S205). If unselected cells remain in the cells 503, 504A, and 504B (NO in step S220), the processor 101 returns to step S211 and selects a new cell from among the unselected cells (step S211). If all of the cells 503, 504A, and 504B have been selected (YES in step S220), the processor 101 ends the third reliability determination process.

The passage time prediction process is a process that executes the passage time prediction process described in the first embodiment on a cell-by-cell basis. This calculates the predicted value T of the passage time for each of the cells 503, 504A, and 504B.

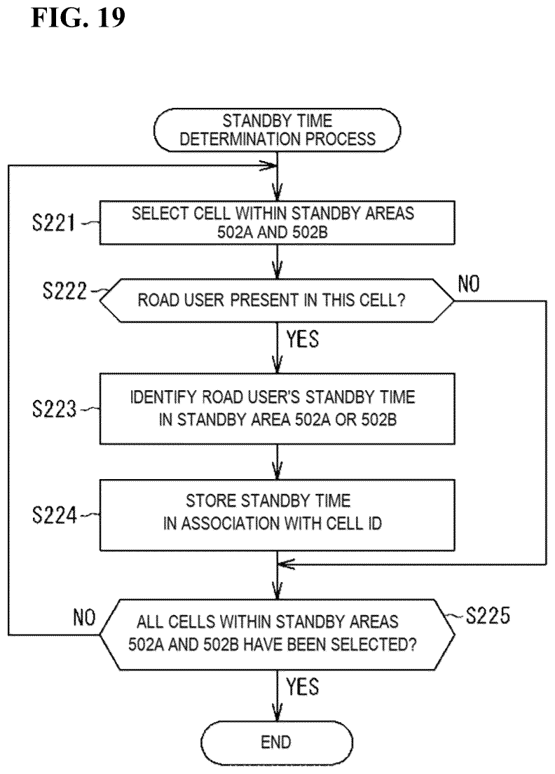

FIG. 19 is a flowchart illustrating an example of the standby time determination process.

The processor 101 selects one of the cells 504A and 504B of the standby areas 502A and 502B (step S221). The processor 101 refers to the presence status and determines whether a road user P is present in the selected cell (step S222). If no road user P is present in the selected cell (NO in step S222), the processor 101 moves to step S225.

If a road user P is present in the selected cell (YES in step S222), the processor 101 refers to the results of the tracking process and identifies the period of time during which the road user P, who is in the selected sell, is located in the standby area 502A or 502B (step S223).

The processor 101 saves the standby time in association with the cell ID of the selected cell in the non-volatile memory 102 (step S224).

The processor 101 determines whether all of the cells 504A and 504B of the standby areas 502A and 502B have been selected (step S225). If unselected cells remain in the cells 504A and 504B (NO in step S225), the processor 101 returns to step S221 and selects a new cell from among the unselected cells (step S221). If all of the cells 504A and 504B have been selected (YES in step S225), the processor 101 ends the standby time determination process.

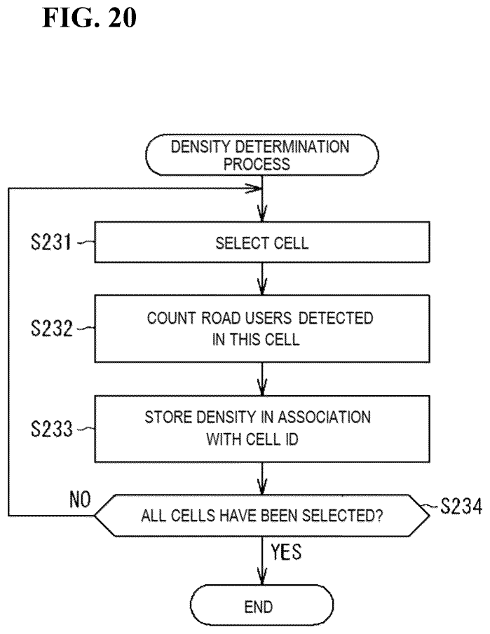

FIG. 20 is a flowchart illustrating an example of the density determination process.

The processor 101 selects one of the cells 503, 504A, and 504B (step S231). The processor 101 refers to the detection results of the object detection process and counts the number of road users P detected in the selected cell (step S232). The processor 101 saves the density according to the number of road users P in association with the cell ID of the selected cell in the non-volatile memory 102 (step S233).

The processor 101 determines whether all of the cells 503, 504A, and 504B have been selected (step S234). If unselected cells remain in the cells 503, 504A, and 504B (NO in step S205), the processor 101 returns to step S231 and selects a new cell from among the unselected cells (step S231). If all of the cells 503, 504A, and 504B have been selected (YES in step S234), the processor 101 ends the density determination process.

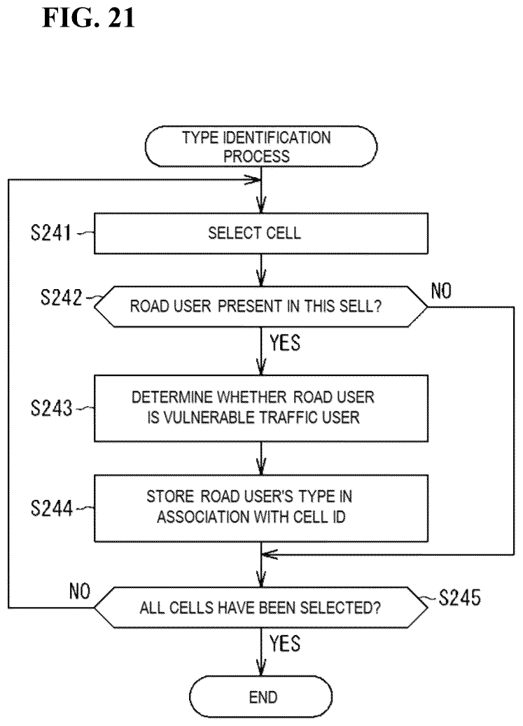

FIG. 21 is a flowchart illustrating an example of the type identification process.

The processor 101 selects one of the cells 503, 504A, and 504B (step S241). The processor 101 refers to the presence status and determines whether a road user P is present in the selected cell (step S242). If no road user P is present in the selected cell (NO in step S242), the processor 101 moves to step S245.

If a road user P is present in the selected cell (YES in step S242), the processor 101 inputs the results of the process of tracking the road user P located in the selected cell to a trained model, for example, and determines whether the road user P is a vulnerable road user or a general road user (step S243). The processor 101 saves the type of the road user P in association with the cell ID of the selected cell in the non-volatile memory 102 (step S244).

The processor 101 determines whether all of the cells 503, 504A, and 504B have been selected (step S245). If unselected cells remain in the cells 503, 504A, and 504B (NO in step S245), the processor 101 returns to step S241 and selects a new cell from among the unselected cells (step S241). If all of the cells 503, 504A, and 504B have been selected (YES in step S245), the processor 101 ends the type identification process.

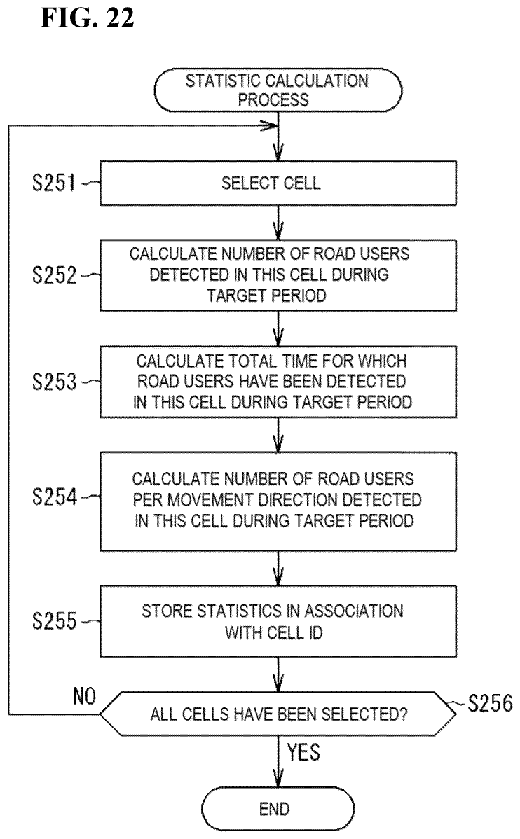

FIG. 22 is a flowchart illustrating an example of the statistic calculation process.

The processor 101 selects one of the cells 503, 504A, and 504B (step S251). The processor 101 refers to the results of the tracking process and counts the number of road users P detected in the selected cell during a target period (step S252).

Furthermore, the processor 101 refers to the results of the tracking process and calculates the total time for which the road users P have been detected in the selected cell during the target period (step S253).

Furthermore, the processor 101 refers to the results of the tracking process and calculates the number of road users P per movement direction detected in that cell during the target period (step S254).

The processor 101 stores the statistics in the non-volatile memory 102, associated with the cell ID of the selected cell, including the number of road users P detected during the target period, the total time for which the road users P have been detected during the target period, and the number of road users P per movement direction detected during the target period (step S255).

The processor 101 determines whether all of the cells 503, 504A, and 504B have been selected (step S256). If unselected cells remain in the cells 503, 504A, and 504B (NO in step S256), the processor 101 returns to step S251 and selects a new cell from among the unselected cells (step S251). If all of the cells 503, 504A, and 504B have been selected (YES in step S256), the processor 101 ends the statistic calculation process.

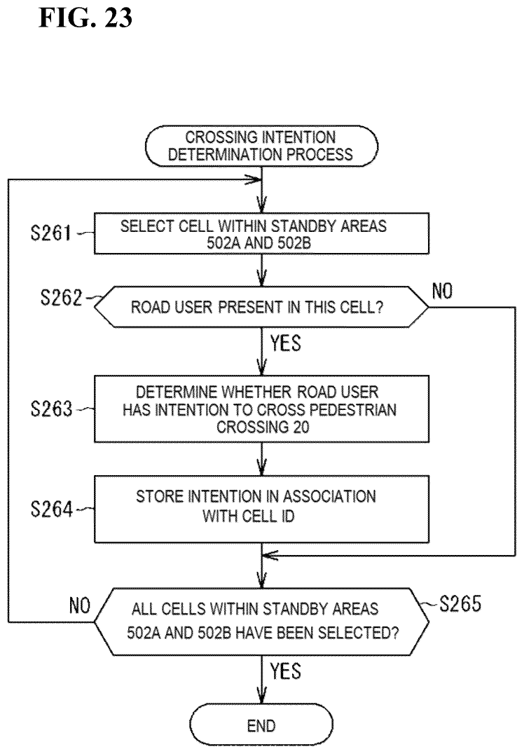

FIG. 23 is a flowchart illustrating an example of the crossing intention determination process.

The processor 101 selects one of the cells 504A and 504B of the standby areas 502A and 502B (step S261). The processor 101 refers to the presence status and determines whether a road user P is present in the selected cell (step S262). If no road user P is present in the selected cell (NO in step S262), the processor 101 moves to step S265.

If a road user P is present in the selected cell (YES in step S262), the processor 101 inputs the results of the process of tracking the road user P located in the selected cell to a trained model, for example, and determines whether the road user P intends to cross the pedestrian crossing 20 (step S263). The processor 101 saves the intention in association with the cell ID of the selected cell in the non-volatile memory 102 (step S264).

The processor 101 determines whether all of the cells 504A and 504B of the standby areas 502A and 502B have been selected (step S265). If unselected cells remain in the cells 504A and 504B (NO in step S265), the processor 101 returns to step S261 and selects a new cell from among the unselected cells (step S261). If all of the cells 504A and 504B have been selected (YES in step S265), the processor 101 ends the crossing intention determination process.

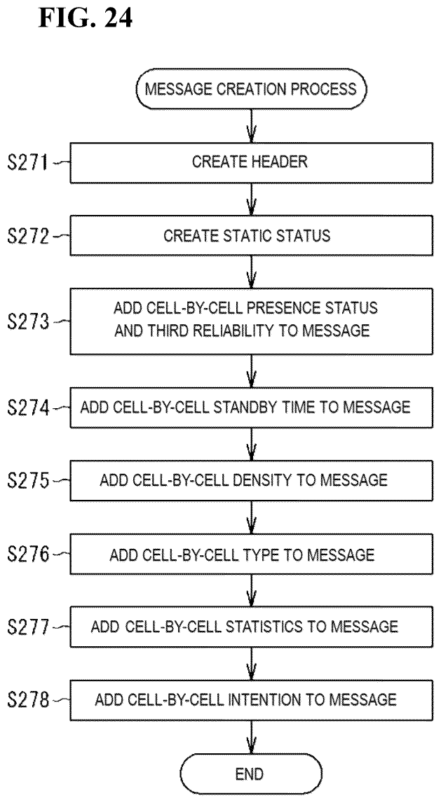

FIG. 24 is a flowchart illustrating an example of the message creation process.

The processor 101 creates a header for a message (step S271) and creates static status (step S272).

The processor 101 then creates dynamic status for the message. First, the processor 101 adds the cell-by-cell presence status and third reliability to the message (step S273). The processor 101 then adds the cell-by-cell standby time to the message (step S274). The processor 101 adds the cell-by-cell density to the message (step S275). The processor 101 adds the cell-by-cell type to the message (step S276). The processor 101 adds the cell-by-cell statistics to the message (step S277). The processor 101 adds the cell-by-cell intention to the message (step S278). At this point, the processor 101 ends the message creation process.

The communication I/F 106 outputs the created message.

### 3. Third Embodiment

An infrastructure radio wave sensor 100 according to a third embodiment may change the format of messages to be output. The server 600 sends the specification content of the format of messages to the infrastructure radio wave sensor 100. The infrastructure radio wave sensor 100 receives the specification content and outputs messages in the designated format.

The infrastructure radio wave sensor 100 according to the third embodiment has the same functions as the infrastructure radio wave sensor 100 according to the second embodiment. That is, the infrastructure radio wave sensor 100 according to the third embodiment includes the object detection unit 111, the presence determination unit 211, the reliability determination unit 212, the prediction unit 213, the standby time determination unit 214, the density determination unit 215, the type identification unit 216, the statistic calculation unit 217, the intention determination unit 218, and the message creation unit 219.

The message creation unit 219 can create messages in a format that includes, for example, only the detection results of the pedestrian crossing area 501, that is, messages in a format that includes the presence status of road users P in the pedestrian crossing area 501, the predicted value of the passage time of the road users P present in the pedestrian crossing area 501, the density in the pedestrian crossing area 501, the type in the pedestrian crossing area 501, and the statistics in the pedestrian crossing area 501. The message creation unit 219 can create messages in a format that includes, for example, only the detection results of the standby areas 502A and 502B, that is, messages in a format that includes the presence status of road users P in the standby areas 502A and 502B, the standby time of the road users P present in the standby areas 502A and 502B, the density in the standby areas 502A and 502B, the type in the standby areas 502A and 502B, the statistics in the standby areas 502A and 502B, and the intention of road users P in the standby areas 502A and 502B.

The message creation unit 219 can create messages in a format that includes only the status for a specific road user P. For example, a message can be created in a format that includes the presence status in a cell where a designated road user P (hereinafter referred to as a “designated road user”) is located, the predicted value of the passage time of the designated road user, the standby time of the designated road user, the density in the cell where the designated road user is located, the type in the cell where the designated road user is located, the statistics of the cell where the designated road user is located, and the designated road user's intention.

The message creation unit 219 can create messages in a format that includes only the predicted value of the passage time of a road user P in the detection area 30 for use in extending the permitted passage period of the pedestrian traffic light 10. This reduces the size of the messages and alleviates the message processing load on the control apparatus 11. This can further suppress the communication delay of the messages.

The message creation unit 219 can create messages in a format that includes only the density and standby time for each of the cells 504A and 504B of the standby areas 502A and 502B for use in controlling the timing for switching the pedestrian traffic light 10 from passage prohibited to passage permitted. This reduces the size of the messages and alleviates the message processing load on the control apparatus 11. This can further suppress the communication delay of the messages.

The infrastructure radio wave sensor 100 can change the size of cells within the detection area 30. For example, one of the three cell sizes, large, medium, and small, can be selected to create a message that includes the detection results of road users P in the selected cell. By creating messages in a format with a large cell size, the infrastructure radio wave sensor 100 reduces the size of the messages and alleviates the message processing load on the control apparatus 11. This can further suppress the communication delay of the messages. By creating messages in a format with a small cell size, the infrastructure radio wave sensor 100 can output messages including the detailed status for the road users P.

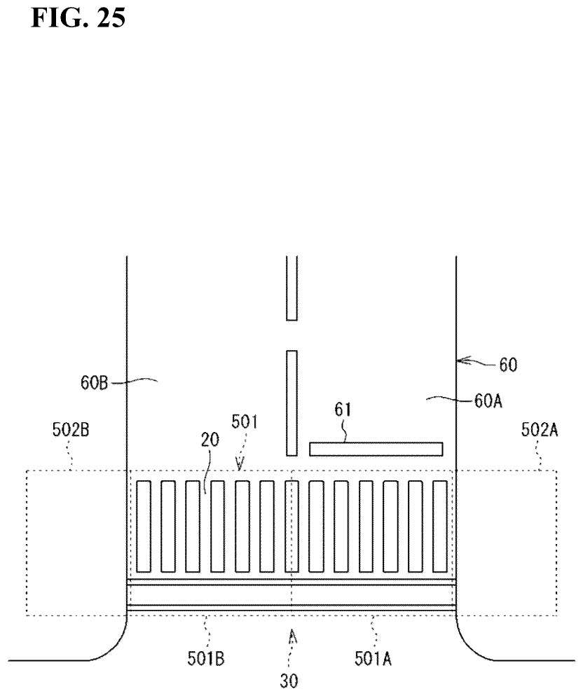

The infrastructure radio wave sensor 100 can also output messages in a format for assisting the driving of vehicles V traveling on the roadway 60. FIG. 25 is a diagram illustrating an example of a detection area for vehicle drive assistance. The detection area 30 illustrated in FIG. 25 includes a first pedestrian crossing area 501A and a second pedestrian crossing area 501B, which are the two divided areas into which the pedestrian crossing area 501 is divided. The first pedestrian crossing area 501A and the second pedestrian crossing area 501B are divided by the center line of the roadway 60. The first pedestrian crossing area 501A is an area where the pedestrian crossing area 501 overlaps with an inflow lane 60A towards the intersection of the roadway 60. The second pedestrian crossing area 501B is an area where the pedestrian crossing area 501 overlaps with an outflow lane 60B from the intersection of the roadway 60.

For example, the infrastructure radio wave sensor 100 can create messages in a format that includes only the presence status of road users P in the first pedestrian crossing area 501A and provide the created messages to vehicles through road-to-vehicle communication. This can assist the driving of vehicles V traveling in the inflow lane 60A. The infrastructure radio wave sensor 100 can create messages in a format that includes only the presence status of road users P in the second pedestrian crossing area 501B and provide the created messages to vehicles through road-to-vehicle communication. This can assist the driving of vehicles V traveling in the outflow lane 60B.

### 4. Supplement

The embodiments disclosed herein are exemplary in all respects and are not limiting. The scope of the present invention is defined by the claims rather than the embodiments described above, and includes all modifications within the meaning and scope of the claims and their equivalents.

### REFERENCE SIGNS LIST

10 pedestrian traffic light
11 control apparatus
20, 20A, 20B pedestrian crossing
30 detection area
40 radio wave irradiation area
50 structure
60 roadway
60A inflow lane
60B outflow lane
61 vehicle stop line
65 intersection
66 restaurant
100 infrastructure radio wave sensor
101 processor
102 non-volatile memory
103 volatile memory
104 transmission circuit
104a transmission antenna
105 reception circuit
105a reception antenna
106 communication interface (communication I/F, output unit, communication unit)
107 input/output interface (I/O)
108 analysis program
111 object detection unit
112 stopped vehicle detection unit
113 counting unit
114 prediction unit
115 sudden event detection unit
116 reliability determination unit
117 message creation unit
150 camera device
151 camera
152 image processing circuit
211 presence determination unit
212 reliability determination unit
213 prediction unit
214 standby time determination unit
215 density determination unit
216 type identification unit
217 statistic calculation unit
218 intention determination unit
219 message creation unit
501 pedestrian crossing area
501A first pedestrian crossing area
501B second pedestrian crossing area
502, 502A, 502B standby area
510 vehicle stop area
503, 504A, 504B cells (divided areas)
600 server
P, P1, P2, P3 road user
V vehicle

1. An infrastructure radio wave sensor comprising:
a transmission circuit configured to transmit radio waves to a detection area that includes a pedestrian crossing;
a reception circuit configured to receive reflected waves that are the radio waves reflected from an object; and
an output circuit configured to output a message created based on a reception result of the reflected waves received by the reception circuit,
wherein the message includes at least one of
a vehicle presence status indicating that a vehicle stopped at a stop line, provided on roadway intersecting the pedestrian crossing, is present,
a number of vehicles indicating a number of vehicles traveling on the roadway, and
an event occurrence status indicating that a sudden event has occurred to a road user on the pedestrian crossing.

2. The infrastructure radio wave sensor according to claim 1, wherein:
the message includes a predicted value of a passage time until the road user on the pedestrian crossing or in a standby area adjacent to the pedestrian crossing finishes crossing the pedestrian crossing, or a predicted value of a passage completion time at which the road user finishes crossing the pedestrian crossing.

3. The infrastructure radio wave sensor according to claim 2, wherein the message includes a reliability of the predicted value of the passage time or the predicted value of the passage completion time.

4. The infrastructure radio wave sensor according to claim 3, wherein:
the reliability of at least one of the predicted value of the passage time and the predicted value of the passage completion time is determined based on at least one of a velocity or an acceleration of the road user, an overlap between objects, a movement direction of the road user, and a tracking time of the road user in the infrastructure radio wave sensor.

5. The infrastructure radio wave sensor according to claim 1, wherein:
the message includes a reliability of the sudden event.

6. The infrastructure radio wave sensor according to claim 5, wherein:
the reliability of the sudden event is determined based on at least one of a time during which the road user is stopped, and an image of the road user captured by a camera.

7. An infrastructure radio wave sensor comprising:
a transmission circuit configured to transmit radio waves to a detection area that includes a pedestrian crossing;
a reception circuit configured to receive reflected waves that are the radio waves reflected from an object; and
an output circuit configured to output a message created based on a reception result of the reflected waves received by the reception circuit,
wherein the message includes
a detection result of a road user in each of a plurality of divided areas into which the detection area is divided.

8. The infrastructure radio wave sensor according to claim 7, wherein:
the message includes, as a detection result of the road user, at least one of
a presence status indicating whether the road user is present for each of the divided areas,
a logical OR of the presence status of the road user,
a predicted value of a passage time until the road user in each of the divided areas finishes crossing the pedestrian crossing or a predicted value of a passage completion time at which the road user finishes crossing the pedestrian crossing,
a standby time of the road user, for each of the divided areas, in a standby area adjacent to the pedestrian crossing,
a density of the road users for each of the divided areas,
a type of an object detected for each of the divided areas,
a statistic of the road user detected for each of the divided areas, and
an intention of the road user in each of the divided areas to cross the pedestrian crossing.

9. The infrastructure radio wave sensor according to claim 8, wherein:
the message includes a reliability of the presence status for each of the divided areas.

10. The infrastructure radio wave sensor according to claim 9, wherein:
the reliability of the presence status is determined based on at least one of a variance value of a position or a velocity of the road user detected in the divided area, an overlap between objects in the divided area, a tracking time of the road user in the infrastructure radio wave sensor, and a likelihood of presence of the road user detected by the infrastructure radio wave sensor.

11. The infrastructure radio wave sensor according to claim 9, wherein:
the message includes a basis for calculating the reliability.

12. The infrastructure radio wave sensor according to claim 1, comprising:
a communication circuit configured to communicate with an external device,
wherein the output circuit sets a format of the message based on a request received by the communication circuit from the external device.

13. The infrastructure radio wave sensor according to claim 2, wherein:
the message includes a reliability of the sudden event.

14. The infrastructure radio wave sensor according to claim 3, wherein:
the message includes a reliability of the sudden event.

15. The infrastructure radio wave sensor according to claim 13, wherein:
the reliability of the sudden event is determined based on at least one of a time during which the road user is stopped, and an image of the road user captured by a camera.

16. The infrastructure radio wave sensor according to claim 14, wherein:
the reliability of the sudden event is determined based on at least one of a time during which the road user is stopped, and an image of the road user captured by a camera.

17. The infrastructure radio wave sensor according to claim 10, wherein:
the message includes a basis for calculating the reliability.

18. The infrastructure radio wave sensor according to claim 2, comprising:
a communication circuit configured to communicate with an external device,
wherein the output circuit sets a format of the message based on a request received by the communication circuit from the external device.

19. The infrastructure radio wave sensor according to claim 3, comprising:
a communication circuit configured to communicate with an external device,
wherein the output circuit sets a format of the message based on a request received by the communication circuit from the external device.

20. The infrastructure radio wave sensor according to claim 4, comprising:
a communication circuit configured to communicate with an external device,
wherein the output circuit sets a format of the message based on a request received by the communication circuit from the external device.
